(19) United States
(12) Patent Application Publication
(10) Pub. No.: US 2026/0119856 A1
(43) Pub. Date: Apr. 30, 2026

(54) SYSTEMS AND METHODS FOR REDUCING MEMORY FOOTPRINT USING AUTOMATED COMPRESSION OF VECTOR EMBEDDINGS WITH SIMILARITY PRESERVATION

(71) Applicant: SAS Institute Inc., Cary, NC (US)

(72) Inventors: Ethan Michael Davis, Lakewood, CO (US); Kevin L Scott, Raleigh, NC (US)

(73) Assignee: SAS Institute Inc., Cary, NC (US)

(21) Appl. No.: 19/195,963

(22) Filed: May 1, 2025

Related U.S. Application Data
(60) Provisional application No. 63/713,378, filed on Oct. 29, 2024.
(60) Provisional application No. 63/725,036, filed on Nov. 26, 2024.

(51) Int. Cl. G06N 3/0495; G06N 3/0985

(52) U.S. Cl. CPC G06N 3/0495; G06N 3/0985

(57) ABSTRACT

A system, method, and computer-program product includes receiving a plurality of vector embeddings having an initial dimensionality and projecting the plurality of vector embeddings into lower-dimensional spaces using at least two different dimension reduction algorithms to generate corresponding sets of projected vector embeddings. Each set of projected embeddings may be quantized and nearest neighbors for the original embeddings and for each quantized set of projected embeddings may be calculated. Additionally, a neighbor preservation metric may be evaluated for each quantized set by comparing its nearest neighbors to those of the original embeddings. Based on the neighbor preservation metrics and a predefined error tolerance, an optimal compression configuration may be selected.

### CROSS-REFERENCE TO RELATED APPLICATIONS

This application claims the benefit of priority to U.S. Patent Application No. 63/725,036, filed on 26 Nov. 2024, which claims benefit of priority to U.S. Patent Application No. 63/713,378, filed on 29 Oct. 2024, incorporated herein by reference in its entirety for all purposes.

### TECHNICAL FIELD

This invention relates generally to data processing architectures and, more specifically, to new and useful systems and methods for reducing memory footprint using compression of vector embeddings that preserves similarity.

### BACKGROUND

In some systems, vector embeddings may be used to represent input data (e.g., documents) in a form that allows for similarity-based retrieval. For example, a system may generate vector embeddings for a collection of documents and store them in a vector database to support retrieval augmented generation (RAG). In such systems, a query may be transformed into an embedding that is compared against the stored embeddings to retrieve relevant contextual information.

As a quantity and dimensionality of vector embeddings increases, storing and managing these embeddings in memory may become increasingly resource intensive. For instance, storing high-dimensional embeddings (e.g., 384 dimensions or more) at full precision may consume additional memory. This may result in increased memory usage, slower query performance, and limitations on scalability (e.g., in environments with constrained storage capacity).

Existing systems may attempt to reduce memory usage by compressing vector embeddings after they have been retrieved from a database. However, such techniques may fail to reduce the memory footprint of the database itself. Other existing systems may apply compression techniques prior to storage. However, these techniques may degrade similarity accuracy such that overall effectiveness of similarity-based retrieval is greatly reduced. The present disclosure may describe systems and methods that enable a reduced memory footprint for the database while better preserving similarity relationships between vector embeddings.

BRIEF SUMMARY OF THE EMBODIMENTS

This summary is not intended to identify only key or essential features of the described subject matter, nor is it intended to be used in isolation to determine the scope of the described subject matter. The subject matter should be understood by reference to appropriate portions of the entire specification of this patent, any or all drawings, and each claim.

In some embodiments, a computer-program product comprising a non-transitory machine-readable storage medium may store computer instructions that, when executed by one or more processors, perform operations comprising: receiving a plurality of vector embeddings having an initial dimension; projecting the plurality of vector embeddings into a plurality of dimensions lower than the initial dimension, wherein projecting the plurality of vector embeddings into the plurality of dimensions lower than the initial dimension includes: generating, via a first dimension reduction algorithm, a first set of projected vector embeddings corresponding to the plurality of dimensions lower than the initial dimension, and generating, via a second dimension reduction algorithm, a second set of projected vector embeddings corresponding to the plurality of dimensions lower than the initial dimension; transforming the first set of projected vector embeddings into a quantized first set of projected vector embeddings and the second set of projected vector embeddings into a quantized second set of projected vector embeddings; computing a set of nearest neighbors for each vector embedding in the plurality of vector embeddings, the quantized first set of projected vector embeddings, and the quantized second set of projected vector embeddings; based on the set of nearest neighbors computed for each vector embedding, computing a neighbor preservation metric for each vector embedding subset in the quantized first set of projected vector embeddings and the quantized second set of projected vector embeddings; and detecting an optimal compression configuration for the plurality of vector embeddings by assessing the neighbor preservation metric computed for each vector embedding subset against a target error tolerance.

In some embodiments, computing the set of nearest neighbors for a respective vector embedding in a target set of vector embeddings corresponding to one of the plurality of vector embeddings, the quantized first set of projected vector embeddings, and the quantized second set of projected vector embeddings includes: computing a plurality of vector distances between the respective vector embedding and additional vector embeddings in the target set of vector embeddings, and based on the plurality of vector distances: detecting a subset of the additional vector embeddings that have a shortest vector distance to the respective vector embedding relative to a remainder of the additional vector embeddings, and selecting the subset of the additional vector embeddings as the set of nearest neighbors for the respective vector embedding.

In some embodiments, the first set of projected vector embeddings generated via the first dimension reduction algorithm at least includes: a first vector embedding subset that projects the plurality of vector embeddings in a first dimension of the plurality of dimensions lower than the initial dimension, and a second vector embedding subset that projects the plurality of vector embeddings in a second dimension of the plurality of dimensions lower than the initial dimension.

In some embodiments, the second set of projected vector embeddings generated via the second dimension reduction algorithm at least includes: a third vector embedding subset that projects the plurality of vector embeddings in the first dimension of the plurality of dimensions lower than the initial dimension, and a fourth vector embedding subset that projects the plurality of vector embeddings in the second dimension of the plurality of dimensions lower than the initial dimension.

In some embodiments, a respective vector embedding in the quantized first set of projected vector embeddings corresponds to a first vector embedding in the first set of projected vector embeddings and has a lower bit precision than a bit precision of first vector embedding, and a respective vector embedding in the quantized second set of projected vector embeddings corresponds to a second vector embedding in the second set of projected vector embeddings and has the lower bit precision than the bit precision of the second vector embedding.

In some embodiments, the first set of projected vector embeddings and the second set of projected vector embeddings are concurrently computed by the first dimension reduction algorithm and the second dimension reduction algorithm, and the first set of projected vector embeddings and the second set of projected vector embeddings are concurrently transformed into the quantized first set of projected vector embeddings and the quantized second set of projected vector embeddings.

In some embodiments, the computer instructions, when executed by the one or more processors, perform the operations further comprising: receiving, as input, the plurality of vector embeddings and a plurality of hyperparameters, including: a hyperparameter that defines the target error tolerance, a hyperparameter that defines a number of nearest neighbors to include in the set of nearest neighbors computed for each vector embedding, and a hyperparameter that defines a compression interval used to determine the plurality of dimensions lower than the initial dimension.

In some embodiments, a respective vector embedding of the plurality of vector embeddings corresponds to a numerical representation of a document in a target embedding space, and the initial dimension corresponds to a number of numerical features included in the numerical representation.

In some embodiments, computing the neighbor preservation metric for a respective vector embedding subset in one of the quantized first set of projected vector embeddings and the quantized second set of projected vector embeddings includes: detecting one or more nearest neighbor variants in the respective vector embedding subset by assessing the set of nearest neighbors computed for each vector embedding in the respective embedding subset against the set of nearest neighbors computed for each vector embedding in the plurality of vector embeddings, and computing a proportion of nearest neighbors preserved in the respective vector embedding subset based on a count of the one or more nearest neighbor variants relative to a total number of nearest neighbors computed across the plurality of vector embeddings.

In some embodiments, the computer instructions, when executed by the one or more processors, perform operations further comprising: computing the set of nearest neighbors for each vector embedding in the plurality of vector embeddings, computing a second set of nearest neighbors for each vector embedding in the plurality of vector embeddings, computing a proportion of nearest neighbors preserved between the set of nearest neighbors and the second set of nearest neighbors computed for each vector embedding in the plurality of vector embeddings, and adjusting the target error tolerance by subtracting the proportion of nearest neighbors preserved between the set of nearest neighbors and the second set of nearest neighbors from the target error tolerance.

In some embodiments, detecting the optimal compression configuration for the plurality of vector embeddings includes: detecting that the neighbor preservation metric computed for a plurality of vector embedding subsets in the quantized first set of projected vector embeddings and the quantized second set of projected vector embeddings satisfy the target error tolerance, detecting that the neighbor preservation metric computed for a first vector embedding subset is associated with a fewer number of components compared to the neighbor preservation metric associated with a remainder of the plurality of vector embedding subsets, and selecting a number of components and a dimension reduction algorithm associated with the neighbor preservation metric computed for the first vector embedding subset as the optimal compression configuration for the plurality of vector embeddings.

In some embodiments, the optimal compression configuration defines an optimal compression level and an optimal dimension reduction algorithm for the plurality of vector embeddings.

In some embodiments, the computer instructions, when executed by the one or more processors, perform operations further comprising: receiving, via an event stream processing engine (ESPE), a plurality of documents; partitioning, via the event stream processing engine, the plurality of documents into a plurality of document segments; computing, via the event stream processing engine, the plurality of vector embeddings corresponding to the plurality of document segments; and receiving, by an automated compression component of the event stream processing engine, the plurality of vector embeddings having the initial dimension.

In some embodiments, the event stream processing engine receives the plurality of documents as a stream over a period of time.

In some embodiments, a respective document of the plurality of documents is a multi-modal document, the multi-modal document comprises at least two distinct modalities, a first modality of the at least two modalities corresponds to one of: video data, image data, audio data, and text data, and a second modality of the at least two modalities corresponds to a different one of: the video data, the image data, the audio data, and the text data.

In some embodiments, the computer instructions, when executed by the one or more processors, perform operations further comprising: installing, via an event stream processing engine (ESPE), the plurality of vector embeddings into a target database using the optimal compression configuration.

In some embodiments, installing the plurality of vector embeddings into the target database using the optimal compression configuration comprises: compressing a first subset of the plurality of vector embeddings using the optimal compression configuration; storing the compressed first subset of the plurality of vector embeddings and a second subset of the plurality of vector embeddings at the target database, wherein the second subset of the plurality of vector embeddings has the initial dimension.

In some embodiments, the computer instructions, when executed by the one or more processors, perform operations further comprising: generating a compression efficacy artifact for the plurality of vector embeddings, wherein the compression efficacy artifact includes one or more of: a first graph depicting a relationship between a number of components and a proportion of nearest neighbors preserved for the first dimension reduction algorithm, a second graph depicting a relationship between the number of components and the proportion of nearest neighbors preserved for the second dimension reduction algorithm, and a third graph depicting a plurality of compression configuration outcomes as a function of loss tolerance and number of neighbors.

In some embodiments, the optimal compression configuration is detected by assessing the neighbor preservation metric computed for each vector embedding subset against the target error tolerance and further based on one or more retrieval-augmented generation (RAG) metrics.

In some embodiments, each of the one or more retrieval-augmented generation metrics measures an efficacy of a large language model in responding to user queries using a respective vector embedding subset of the quantized first set of projected vector embeddings and the quantized second set of projected vector embedding.

In some embodiments, detecting the optimal compression configuration for the plurality of vector embeddings includes: detecting that the neighbor preservation metric computed for a first vector embedding subset and the neighbor preservation metric computed for a second vector embedding subset in the quantized first set of projected vector embeddings and the quantized second set of projected vector embeddings satisfy the target error tolerance, detecting that a first retrieval-augmented generation metric satisfies pre-defined efficacy criteria and a second retrieval-augmented generation metric does not satisfy the pre-defined efficacy criteria, and in response to detecting that the first retrieval-augmented generation metric satisfies the pre-defined efficacy criteria and the second retrieval-augmented generation metric does not satisfy the pre-defined efficacy criteria: determining that the optimal compression configuration is associated with the first vector embedding subset if the respective vector embedding subset associated with the first retrieval-augmented generation metric corresponds to the first vector embedding subset.

In some embodiments, in response to detecting that the first retrieval-augmented generation metric satisfies the pre-defined efficacy criteria and the second retrieval-augmented generation metric does not satisfy the pre-defined efficacy criteria: detecting that the optimal compression configuration is associated with the second vector embedding subset when the respective vector embedding subset associated with the first retrieval-augmented generation metric corresponds to the second vector embedding subset.

In some embodiments, the set of nearest neighbors are further computed for each vector embedding in the first set of projected vector embeddings and the second set of projected vector embeddings, the neighbor preservation metric is further computed for each vector embedding subset in the first set of projected vector embeddings and the second set of projected vector embeddings, and detecting the optimal compression configuration for the plurality of vector embeddings includes: detecting that the neighbor preservation metric computed for each vector embedding subset in the quantized first set of projected vector embeddings and the quantized second set of projected vector embeddings does not satisfy the target error tolerance, detecting that the neighbor preservation metric computed for a first vector embedding subset in the first set of projected vector embeddings satisfies the target error tolerance, and selecting a number of components and a dimension reduction algorithm associated with the neighbor preservation metric computed for the first vector embedding subset as the optimal compression configuration for the plurality of vector embeddings.

In some embodiments, the plurality of vector embeddings exceed a target memory size, the neighbor preservation metric computed for a respective vector embedding subset of the quantized first set of projected vector embeddings and the quantized second set of projected vector embeddings satisfies the target error tolerance, and the respective vector embedding subset associated with the neighbor preservation metric does not exceed the target memory size.

In some embodiments, an edge device defines the target memory size for storing the plurality of vector embeddings.

In some embodiments, the computer instructions, when executed by the one or more processors, perform the operations comprising: receiving a second plurality of vector embeddings having a second initial dimension, different from the initial dimension, and detecting a second optimal compression configuration for the second plurality of vector embeddings.

In some embodiments, the computer instructions, when executed by the one or more processors, perform the operations further comprising: outputting, to a graphical user interface, an indication of the detected optimal compression configuration.

In some embodiments, a computer-implemented method may comprise: receiving a plurality of vector embeddings having an initial dimension; projecting the plurality of vector embeddings into a plurality of dimensions lower than the initial dimension, wherein projecting the plurality of vector embeddings into the plurality of dimensions lower than the initial dimension includes: generating, via a first dimension reduction algorithm, a first set of projected vector embeddings corresponding to the plurality of dimensions lower than the initial dimension, and generating, via a second dimension reduction algorithm, a second set of projected vector embeddings corresponding to the plurality of dimensions lower than the initial dimension; transforming the first set of projected vector embeddings into a quantized first set of projected vector embeddings and the second set of projected vector embeddings into a quantized second set of projected vector embeddings; computing a set of nearest neighbors for each vector embedding in the plurality of vector embeddings, the quantized first set of projected vector embeddings, and the quantized second set of projected vector embeddings; based on the set of nearest neighbors computed for each vector embedding, computing a neighbor preservation metric for each vector embedding subset in the quantized first set of projected vector embeddings and the quantized second set of projected vector embeddings; and detecting an optimal compression configuration for the plurality of vector embeddings by assessing the neighbor preservation metric computed for each vector embedding subset against a target error tolerance.

In some embodiments, a computer-implemented system may comprise: one or more processors; a memory; and a computer-readable medium operably coupled to the one or more processors, the computer-readable medium having computer-readable instructions stored thereon that, when executed by the one or more processors, cause a computing device to perform operations comprising: receiving a plurality of vector embeddings having an initial dimension; projecting the plurality of vector embeddings into a plurality of dimensions lower than the initial dimension, wherein projecting the plurality of vector embeddings into the plurality of dimensions lower than the initial dimension includes: generating, via a first dimension reduction algorithm, a first set of projected vector embeddings corresponding to the plurality of dimensions lower than the initial dimension, and generating, via a second dimension reduction algorithm, a second set of projected vector embeddings corresponding to the plurality of dimensions lower than the initial dimension; transforming the first set of projected vector embeddings into a quantized first set of projected vector embeddings and the second set of projected vector embeddings into a quantized second set of projected vector embeddings; computing a set of nearest neighbors for each vector embedding in the plurality of vector embeddings, the quantized first set of projected vector embeddings, and the quantized second set of projected vector embeddings; based on the set of nearest neighbors computed for each vector embedding, computing a neighbor preservation metric for each vector embedding subset in the quantized first set of projected vector embeddings and the quantized second set of projected vector embeddings; and detecting an optimal compression configuration for the plurality of vector embeddings by assessing the neighbor preservation metric computed for each vector embedding subset against a target error tolerance.

### BRIEF DESCRIPTION OF THE FIGURES

FIG. 1 illustrates a block diagram that provides an illustration of the hardware components of a computing system, according to some embodiments of the present technology.

FIG. 2 illustrates an example network including an example set of devices communicating with each other over an exchange system and via a network, according to some embodiments of the present technology.

FIG. 3 illustrates a representation of a conceptual model of a communications protocol system, according to some embodiments of the present technology.

FIG. 4 illustrates a communications grid computing system including a variety of control and worker nodes, according to some embodiments of the present technology.

FIG. 5 illustrates a flow chart showing an example process for adjusting a communications grid or a work project in a communications grid after a failure of a node, according to some embodiments of the present technology.

FIG. 6 illustrates a portion of a communications grid computing system including a control node and a worker node, according to some embodiments of the present technology.

FIG. 7 illustrates a flow chart showing an example process for executing a data analysis or processing project, according to some embodiments of the present technology.

FIG. 8 illustrates a block diagram including components of an Event Stream Processing Engine (ESPE), according to some embodiments of the present technology.

FIG. 9 illustrates a flow chart showing an example process including operations performed by an event stream processing engine, according to some embodiments of the present technology.

FIG. 10 illustrates an ESP system interfacing between a publishing device and multiple event subscribing devices, according to some embodiments of the present technology.

FIG. 11 illustrates a flow chart of an example of a process for generating and using a machine-learning model according to some aspects, according to some embodiments of the present technology.

FIG. 12 illustrates an example of a machine-learning model as a neural network, according to some embodiments of the present technology.

FIG. 13 illustrates various aspects of the use of containers as a mechanism to allocate processing, storage and/or other resources of a processing system to the performance of various analyses, according to some embodiments of the present technology.

FIG. 14 illustrates a flow chart showing an example process that enables reduced memory footprint using automated compression of vector embeddings with similarity preservation according to some embodiments of the present technology.

FIGS. 15A-1 and 15A-2 illustrates an example compression configuration selection process that enables reduced memory footprint using automated compression of vector embeddings with similarity preservation, according to some embodiments of the present technology.

FIG. 15B illustrates an example nearest neighbors detection process according to some embodiments of the present technology.

FIG. 15C illustrates an example automated vector embedding compression system according to some embodiments of the present technology.

FIG. 15D illustrates an example system according to some embodiments of the present technology.

FIGS. 15E and 15F illustrate example nearest neighbor preservation plots according to some embodiments of the present technology.

FIG. 15G illustrates an example compression configuration plot according to some embodiments of the present technology.

### DESCRIPTION OF THE PREFERRED EMBODIMENTS

The following description of the preferred embodiments of the inventions are not intended to limit the inventions to these preferred embodiments, but rather to enable any person skilled in the art to make and use these inventions.

### DETAILED DESCRIPTION

In the following description, for the purposes of explanation, specific details are set forth in order to provide a thorough understanding of embodiments of the technology. However, it will be apparent that various embodiments may be practiced without these specific details. The figures and description are not intended to be restrictive.

The ensuing description provides example embodiments only, and is not intended to limit the scope, applicability, or configuration of the disclosure. Rather, the ensuing description of the example embodiments will provide those skilled in the art with an enabling description for implementing an example embodiment. It should be understood that various changes may be made in the function and arrangement of elements without departing from the spirit and scope of the technology as set forth in the appended claims.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional operations not included in a figure. A process may correspond to a method, a function, a procedure, a subroutine, a subprogram, etc. When a process corresponds to a function, its termination can correspond to a return of the function to the calling function or the main function.

### Example Systems

Systems depicted in some of the figures may be provided in various configurations. In some embodiments, the systems may be configured as a distributed system where one or more components of the system are distributed across one or more networks in a cloud computing system.

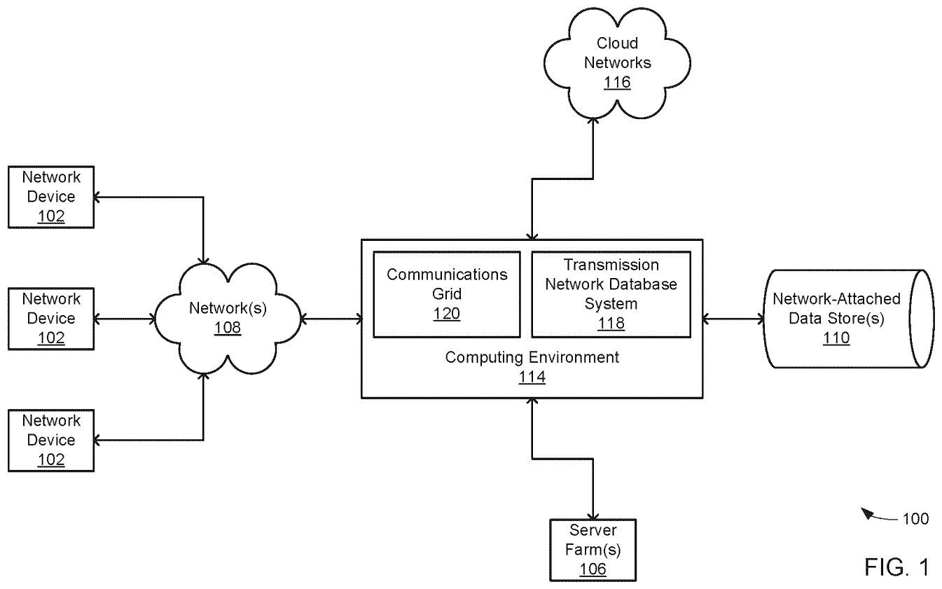

FIG. 1 is a block diagram that provides an illustration of the hardware components of a data transmission network 100, according to embodiments of the present technology. Data transmission network 100 is a specialized computer system that may be used for processing large amounts of data where a large number of computer processing cycles are required.

Data transmission network 100 may also include computing environment 114. Computing environment 114 may be a specialized computer or other machine that processes the data received within the data transmission network 100. Data transmission network 100 also includes one or more network devices 102. Network devices 102 may include client devices that attempt to communicate with computing environment 114. For example, network devices 102 may send data to the computing environment 114 to be processed, may send signals to the computing environment 114 to control different aspects of the computing environment or the data it is processing, among other reasons. Network devices 102 may interact with the computing environment 114 through a number of ways, such as, for example, over one or more networks 108. As shown in FIG. 1, computing environment 114 may include one or more other systems. For example, computing environment 114 may include a database system 118 and/or a communications grid 120.

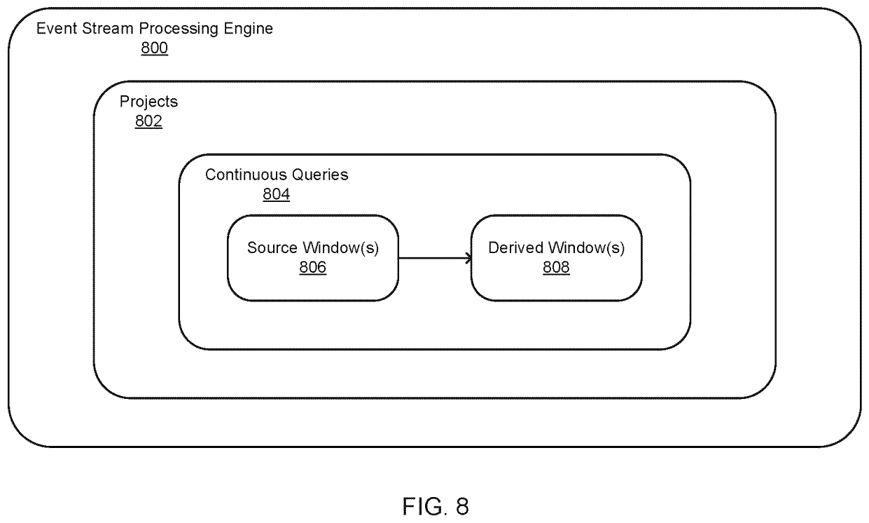

In other embodiments, network devices may provide a large amount of data, either all at once or streaming over a period of time (e.g., using event stream processing (ESP), described further with respect to FIGS. 8-10), to the computing environment 114 via networks 108. For example, network devices 102 may include network computers, sensors, databases, or other devices that may transmit or otherwise provide data to computing environment 114. For example, network devices may include local area network devices, such as routers, hubs, switches, or other computer networking devices. These devices may provide a variety of stored or generated data, such as network data or data specific to the network devices themselves. Network devices may also include sensors that monitor their environment or other devices to collect data regarding that environment or those devices, and such network devices may provide data they collect over time. Network devices may also include devices within the internet of things, such as devices within a home automation network. Some of these devices may be referred to as edge devices and may involve edge computing circuitry. Data may be transmitted by network devices directly to computing environment 114 or to network-attached data stores, such as network-attached data stores 110 for storage so that the data may be retrieved later by the computing environment 114 or other portions of data transmission network 100.

Data transmission network 100 may also include one or more network-attached data stores 110. Network-attached data stores 110 are used to store data to be processed by the computing environment 114 as well as any intermediate or final data generated by the computing system in non-volatile memory. However, in certain embodiments, the configuration of the computing environment 114 allows its operations to be performed such that intermediate and final data results can be stored solely in volatile memory (e.g., RAM), without a requirement that intermediate or final data results be stored to non-volatile types of memory (e.g., disk). This can be useful in certain situations, such as when the computing environment 114 receives ad hoc queries from a user and when responses, which are generated by processing large amounts of data, need to be generated on-the-fly. In this non-limiting situation, the computing environment 114 may be configured to retain the processed information within memory so that responses can be generated for the user at different levels of detail as well as allow a user to interactively query against this information.

Network-attached data stores may store a variety of different types of data organized in a variety of different ways and from a variety of different sources. For example, network-attached data storage may include storage other than primary storage located within computing environment 114 that is directly accessible by processors located therein. Network-attached data storage may include secondary, tertiary or auxiliary storage, such as large hard drives, servers, virtual memory, among other types. Storage devices may include portable or non-portable storage devices, optical storage devices, and various other mediums capable of storing, containing data. A machine-readable storage medium or computer-readable storage medium may include a non-transitory medium in which data can be stored and that does not include carrier waves and/or transitory electronic signals. Examples of a non-transitory medium may include, for example, a magnetic disk or tape, optical storage media such as compact disk or digital versatile disk, flash memory, memory or memory devices. A computer-program product may include code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, among others. Furthermore, the data stores may hold a variety of different types of data. For example, network-attached data stores 110 may hold unstructured (e.g., raw) data, such as manufacturing data (e.g., a database containing records identifying products being manufactured with parameter data for each product, such as colors and models) or product sales databases (e.g., a database containing individual data records identifying details of individual product sales).

The unstructured data may be presented to the computing environment 114 in different forms such as a flat file or a conglomerate of data records and may have data values and accompanying time stamps. The computing environment 114 may be used to analyze the unstructured data in a variety of ways to determine the best way to structure (e.g., hierarchically) that data, such that the structured data is tailored to a type of further analysis that a user wishes to perform on the data. For example, after being processed, the unstructured time stamped data may be aggregated by time (e.g., into daily time period units) to generate time series data and/or structured hierarchically according to one or more dimensions (e.g., parameters, attributes, and/or variables). For example, data may be stored in a hierarchical data structure, such as a ROLAP OR MOLAP database, or may be stored in another tabular form, such as in a flat-hierarchy form.

Data transmission network 100 may also include one or more server farms 106. Computing environment 114 may route select communications or data to the one or more server farms 106 or one or more servers within the server farms. Server farms 106 can be configured to provide information in a predetermined manner. For example, server farms 106 may access data to transmit in response to a communication. Server farms 106 may be separately housed from each other device within data transmission network 100, such as computing environment 114, and/or may be part of a device or system.

Server farms 106 may host a variety of different types of data processing as part of data transmission network 100. Server farms 106 may receive a variety of different data from network devices, from computing environment 114, from cloud network 116, or from other sources. The data may have been obtained or collected from one or more sensors, as inputs from a control database, or may have been received as inputs from an external system or device. Server farms 106 may assist in processing the data by turning raw data into processed data based on one or more rules implemented by the server farms. For example, sensor data may be analyzed to determine changes in an environment over time or in real-time.

Data transmission network 100 may also include one or more cloud networks 116. Cloud network 116 may include a cloud infrastructure system that provides cloud services. In certain embodiments, services provided by the cloud network 116 may include a host of services that are made available to users of the cloud infrastructure system on demand. Cloud network 116 is shown in FIG. 1 as being connected to computing environment 114 (and therefore having computing environment 114 as its client or user), but cloud network 116 may be connected to or utilized by any of the devices in FIG. 1. Services provided by the cloud network can dynamically scale to meet the needs of its users. The cloud network 116 may include one or more computers, servers, and/or systems. In some embodiments, the computers, servers, and/or systems that make up the cloud network 116 are different from the user's own on-premises computers, servers, and/or systems. For example, the cloud network 116 may host an application, and a user may, via a communication network such as the Internet, on demand, order and use the application.

While each device, server and system in FIG. 1 is shown as a single device, it will be appreciated that multiple devices may instead be used. For example, a set of network devices can be used to transmit various communications from a single user, or remote server 140 may include a server stack. As another example, data may be processed as part of computing environment 114.

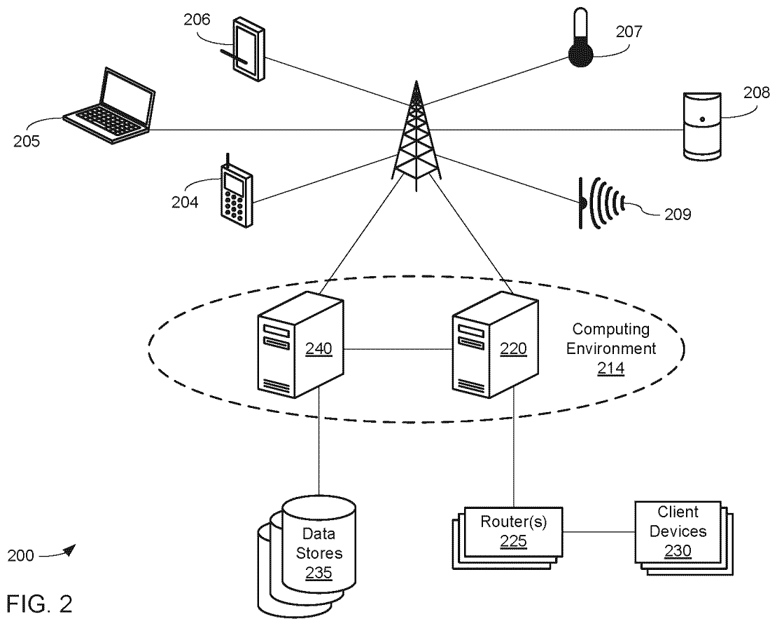

Each communication within data transmission network 100 (e.g., between client devices, between servers 106 and computing environment 114 or between a server and a device) may occur over one or more networks 108. Networks 108 may include one or more of a variety of different types of networks, including a wireless network, a wired network, or a combination of a wired and wireless network. Examples of suitable networks include the Internet, a personal area network, a local area network (LAN), a wide area network (WAN), or a wireless local area network (WLAN). A wireless network may include a wireless interface or combination of wireless interfaces. As an example, a network in the one or more networks 108 may include a short-range communication channel, such as a BLUETOOTH® communication channel or a BLUETOOTH® LOW Energy communication channel. A wired network may include a wired interface. The wired and/or wireless networks may be implemented using routers, access points, bridges, gateways, or the like, to connect devices in the network 114, as will be further described with respect to FIG. 2. The one or more networks 108 can be incorporated entirely within or can include an intranet, an extranet, or a combination thereof. In one embodiment, communications between two or more systems and/or devices can be achieved by a secure communications protocol, such as secure sockets layer (SSL) or transport layer security (TLS). In addition, data and/or transactional details may be encrypted.

Some aspects may utilize the Internet of Things (IoT), where things (e.g., machines, devices, phones, sensors) can be connected to networks and the data from these things can be collected and processed within the things and/or external to the things. For example, the IoT can include sensors in many different devices, and high value analytics can be applied to identify hidden relationships and drive increased efficiencies. This can apply to both big data analytics and real-time (e.g., ESP) analytics. This will be described further below with respect to FIG. 2.

As noted, computing environment 114 may include a communications grid 120 and a transmission network database system 118. Communications grid 120 may be a grid-based computing system for processing large amounts of data. The transmission network database system 118 may be for managing, storing, and retrieving large amounts of data that are distributed to and stored in the one or more network-attached data stores 110 or other data stores that reside at different locations within the transmission network database system 118. The compute nodes in the grid-based computing system 120 and the transmission network database system 118 may share the same processor hardware, such as processors that are located within computing environment 114.

FIG. 2 illustrates an example network including an example set of devices communicating with each other over an exchange system and via a network, according to embodiments of the present technology. As noted, each communication within data transmission network 100 may occur over one or more networks. System 200 includes a network device 204 configured to communicate with a variety of types of client devices, for example client devices 230, over a variety of types of communication channels.

As shown in FIG. 2, network device 204 can transmit a communication over a network (e.g., a cellular network via a base station 210). The communication can be routed to another network device, such as network devices 205-209, via base station 210. The communication can also be routed to computing environment 214 via base station 210. For example, network device 204 may collect data either from its surrounding environment or from other network devices (such as network devices 205-209) and transmit that data to computing environment 214.

Although network devices 204-209 are shown in FIG. 2 as a mobile phone, laptop computer, tablet computer, temperature sensor, motion sensor, and audio sensor respectively, the network devices may be or include sensors that are sensitive to detecting aspects of their environment. For example, the network devices may include sensors such as water sensors, power sensors, electrical current sensors, chemical sensors, optical sensors, pressure sensors, geographic or position sensors (e.g., GPS), velocity sensors, acceleration sensors, flow rate sensors, among others. Examples of characteristics that may be sensed include force, torque, load, strain, position, temperature, air pressure, fluid flow, chemical properties, resistance, electromagnetic fields, radiation, irradiance, proximity, acoustics, moisture, distance, speed, vibrations, acceleration, electrical potential, and electrical current, among others. The sensors may be mounted to various components used as part of a variety of different types of systems (e.g., an oil drilling operation). The network devices may detect and record data related to the environment that it monitors and transmit that data to computing environment 214.

As noted, one type of system that may include various sensors that collect data to be processed and/or transmitted to a computing environment according to certain embodiments includes an oil drilling system. For example, the one or more drilling operation sensors may include surface sensors that measure a hook load, a fluid rate, a temperature and a density in and out of the wellbore, a standpipe pressure, a surface torque, a rotation speed of a drill pipe, a rate of penetration, a mechanical specific energy, etc. and downhole sensors that measure a rotation speed of a bit, fluid densities, downhole torque, downhole vibration (axial, tangential, lateral), a weight applied at a drill bit, an annular pressure, a differential pressure, an azimuth, an inclination, a dog leg severity, a measured depth, a vertical depth, a downhole temperature, etc. Besides the raw data collected directly by the sensors, other data may include parameters either developed by the sensors or assigned to the system by a client or other controlling device. For example, one or more drilling operation control parameters may control settings such as a mud motor speed to flow ratio, a bit diameter, a predicted formation top, seismic data, weather data, etc. Other data may be generated using physical models such as an earth model, a weather model, a seismic model, a bottom hole assembly model, a well plan model, an annular friction model, etc. In addition to sensor and control settings, predicted outputs, of for example, the rate of penetration, mechanical specific energy, hook load, flow in fluid rate, flow out fluid rate, pump pressure, surface torque, rotation speed of the drill pipe, annular pressure, annular friction pressure, annular temperature, equivalent circulating density, etc. may also be stored in the data warehouse.

In another example, another type of system that may include various sensors that collect data to be processed and/or transmitted to a computing environment according to certain embodiments includes a home automation or similar automated network in a different environment, such as an office space, school, public space, sports venue, or a variety of other locations. Network devices in such an automated network may include network devices that allow a user to access, control, and/or configure various home appliances located within the user's home (e.g., a television, radio, light, fan, humidifier, sensor, microwave, iron, and/or the like), or outside of the user's home (e.g., exterior motion sensors, exterior lighting, garage door openers, sprinkler systems, or the like). For example, network device 102 may include a home automation switch that may be coupled with a home appliance. In another embodiment, a network device can allow a user to access, control, and/or configure devices, such as office-related devices (e.g., copy machine, printer, or fax machine), audio and/or video related devices (e.g., a receiver, a speaker, a projector, a DVD player, or a television), media-playback devices (e.g., a compact disc player, a CD player, or the like), computing devices (e.g., a home computer, a laptop computer, a tablet, a personal digital assistant (PDA), a computing device, or a wearable device), lighting devices (e.g., a lamp or recessed lighting), devices associated with a security system, devices associated with an alarm system, devices that can be operated in an automobile (e.g., radio devices, navigation devices), and/or the like. Data may be collected from such various sensors in raw form, or data may be processed by the sensors to create parameters or other data either developed by the sensors based on the raw data or assigned to the system by a client or other controlling device.

In another example, another type of system that may include various sensors that collect data to be processed and/or transmitted to a computing environment according to certain embodiments includes a power or energy grid. A variety of different network devices may be included in an energy grid, such as various devices within one or more power plants, energy farms (e.g., wind farm, solar farm, among others) energy storage facilities, factories, homes and businesses of consumers, among others. One or more of such devices may include one or more sensors that detect energy gain or loss, electrical input or output or loss, and a variety of other efficiencies. These sensors may collect data to inform users of how the energy grid, and individual devices within the grid, may be functioning and how they may be made more efficient.

Network device sensors may also perform processing on data it collects before transmitting the data to the computing environment 114, or before deciding whether to transmit data to the computing environment 114. For example, network devices may determine whether data collected meets certain rules, for example by comparing data or values calculated from the data and comparing that data to one or more thresholds. The network device may use this data and/or comparisons to determine if the data should be transmitted to the computing environment 214 for further use or processing.

Computing environment 214 may include machines 220 and 240. Although computing environment 214 is shown in FIG. 2 as having two machines, 220 and 240, computing environment 214 may have only one machine or may have more than two machines. The machines that make up computing environment 214 may include specialized computers, servers, or other machines that are configured to individually and/or collectively process large amounts of data. The computing environment 214 may also include storage devices that include one or more databases of structured data, such as data organized in one or more hierarchies, or unstructured data. The databases may communicate with the processing devices within computing environment 214 to distribute data to them. Since network devices may transmit data to computing environment 214, that data may be received by the computing environment 214 and subsequently stored within those storage devices. Data used by computing environment 214 may also be stored in data stores 235, which may also be a part of or connected to computing environment 214.

Computing environment 214 can communicate with various devices via one or more routers 225 or other inter-network or intra-network connection components. For example, computing environment 214 may communicate with devices 230 via one or more routers 225. Computing environment 214 may collect, analyze and/or store data from or pertaining to communications, client device operations, client rules, and/or user-associated actions stored at one or more data stores 235. Such data may influence communication routing to the devices within computing environment 214, how data is stored or processed within computing environment 214, among other actions.

Notably, various other devices can further be used to influence communication routing and/or processing between devices within computing environment 214 and with devices outside of computing environment 214. For example, as shown in FIG. 2, computing environment 214 may include a web server 240. Thus, computing environment 214 can retrieve data of interest, such as client information (e.g., product information, client rules, etc.), technical product details, news, current or predicted weather, and so on.

In addition to computing environment 214 collecting data (e.g., as received from network devices, such as sensors, and client devices or other sources) to be processed as part of a big data analytics project, it may also receive data in real time as part of a streaming analytics environment. As noted, data may be collected using a variety of sources as communicated via different kinds of networks or locally. Such data may be received on a real-time streaming basis. For example, network devices may receive data periodically from network device sensors as the sensors continuously sense, monitor and track changes in their environments. Devices within computing environment 214 may also perform pre-analysis on data it receives to determine if the data received should be processed as part of an ongoing project. The data received and collected by computing environment 214, no matter what the source or method or timing of receipt, may be processed over a period of time for a client to determine results data based on the client's needs and rules.

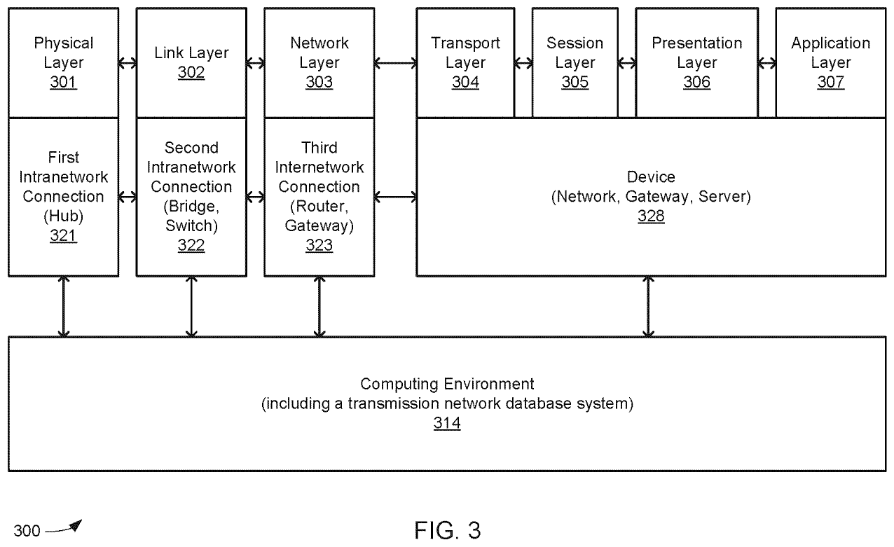

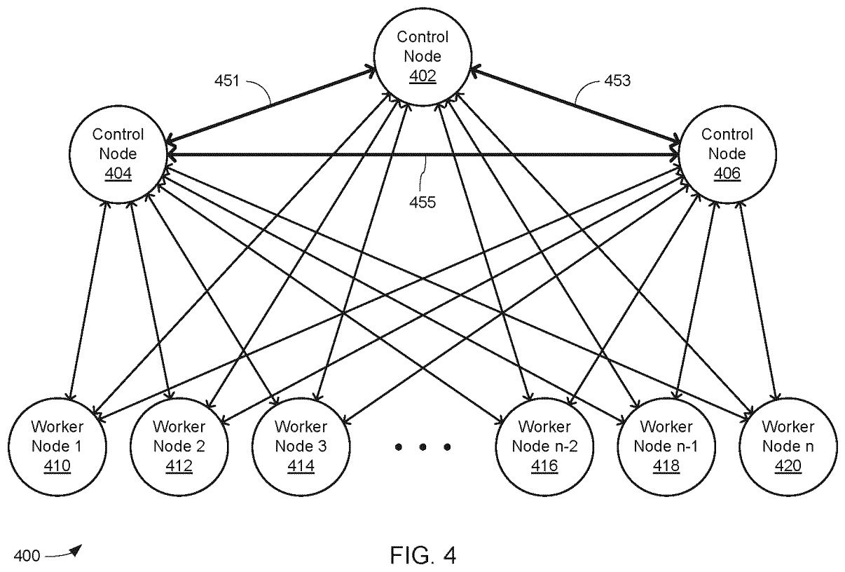

FIG. 3 illustrates a representation of a conceptual model of a communications protocol system, according to embodiments of the present technology. More specifically, FIG. 3 identifies operation of a computing environment in an Open Systems Interaction model that corresponds to various connection components. The model 300 shows, for example, how a computing environment, such as computing environment 314 (or computing environment 214 in FIG. 2) may communicate with other devices in its network, and control how communications between the computing environment and other devices are executed and under what conditions.

The model can include layers 301-307. The layers are arranged in a stack. Each layer in the stack serves the layer one level higher than it (except for the application layer, which is the highest layer), and is served by the layer one level below it (except for the physical layer, which is the lowest layer). The physical layer is the lowest layer because it receives and transmits raw bites of data and is the farthest layer from the user in a communications system. On the other hand, the application layer is the highest layer because it interacts directly with a software application.

As noted, the model includes a physical layer 301. Physical layer 301 represents physical communication and can define parameters of that physical communication. For example, such physical communication may come in the form of electrical, optical, or electromagnetic signals. Physical layer 301 also defines protocols that may control communications within a data transmission network.

Link layer 302 defines links and mechanisms used to transmit (i.e., move) data across a network. The link layer 302 manages node-to-node communications, such as within a grid computing environment. Link layer 302 can detect and correct errors (e.g., transmission errors in the physical layer 301). Link layer 302 can also include a media access control (MAC) layer and logical link control (LLC) layer.

Network layer 303 defines the protocol for routing within a network. In other words, the network layer coordinates transferring data across nodes in a same network (e.g., such as a grid computing environment). Network layer 303 can also define the processes used to structure local addressing within the network.

Transport layer 304 can manage the transmission of data and the quality of the transmission and/or receipt of that data. Transport layer 304 can provide a protocol for transferring data, such as, for example, a Transmission Control Protocol (TCP). Transport layer 304 can assemble and disassemble data frames for transmission. The transport layer can also detect transmission errors occurring in the layers below it.

Session layer 305 can establish, maintain, and manage communication connections between devices on a network. In other words, the session layer controls the dialogues or nature of communications between network devices on the network. The session layer may also establish checkpointing, adjournment, termination, and restart procedures.

Presentation layer 306 can provide translation for communications between the application and network layers. In other words, this layer may encrypt, decrypt and/or format data based on data types and/or encodings known to be accepted by an application or network layer.

Application layer 307 interacts directly with software applications and end users and manages communications between them. Application layer 307 can identify destinations, local resource states or availability and/or communication content or formatting using the applications.

Intra-network connection components 321 and 322 are shown to operate in lower levels, such as physical layer 301 and link layer 302, respectively. For example, a hub can operate in the physical layer, a switch can operate in the link layer, and a router can operate in the network layer. Inter-network connection components 323 and 328 are shown to operate on higher levels, such as layers 303-307. For example, routers can operate in the network layer and network devices can operate in the transport, session, presentation, and application layers.

As noted, a computing environment 314 can interact with and/or operate on, in various embodiments, one, more, all or any of the various layers. For example, computing environment 314 can interact with a hub (e.g., via the link layer) so as to adjust which devices the hub communicates with. The physical layer may be served by the link layer, so it may implement such data from the link layer. For example, the computing environment 314 may control which devices it will receive data from. For example, if the computing environment 314 knows that a certain network device has turned off, broken, or otherwise become unavailable or unreliable, the computing environment 314 may instruct the hub to prevent any data from being transmitted to the computing environment 314 from that network device. Such a process may be beneficial to avoid receiving data that is inaccurate or that has been influenced by an uncontrolled environment. As another example, computing environment 314 can communicate with a bridge, switch, router or gateway and influence which device within the system (e.g., system 200) the component selects as a destination. In some embodiments, computing environment 314 can interact with various layers by exchanging communications with equipment operating on a particular layer by routing or modifying existing communications. In another embodiment, such as in a grid computing environment, a node may determine how data within the environment should be routed (e.g., which node should receive certain data) based on certain parameters or information provided by other layers within the model.

As noted, the computing environment 314 may be a part of a communications grid environment, the communications of which may be implemented as shown in the protocol of FIG. 3. For example, referring back to FIG. 2, one or more of machines 220 and 240 may be part of a communications grid computing environment. A gridded computing environment may be employed in a distributed system with non-interactive workloads where data resides in memory on the machines, or compute nodes. In such an environment, analytic code, instead of a database management system, controls the processing performed by the nodes. Data is co-located by pre-distributing it to the grid nodes, and the analytic code on each node loads the local data into memory. Each node may be assigned a particular task such as a portion of a processing project, or to organize or control other nodes within the grid.

FIG. 4 illustrates a communications grid computing system 400 including a variety of control and worker nodes, according to embodiments of the present technology. Communications grid computing system 400 includes three control nodes and one or more worker nodes. Communications grid computing system 400 includes control nodes 402, 404, and 406. The control nodes are communicatively connected via communication paths 451, 453, and 455. Therefore, the control nodes may transmit information (e.g., related to the communications grid or notifications), to and receive information from each other. Although communications grid computing system 400 is shown in FIG. 4 as including three control nodes, the communications grid may include more or less than three control nodes.

Communications grid computing system (or just “communications grid”) 400 also includes one or more worker nodes. Shown in FIG. 4 are six worker nodes 410-420. Although FIG. 4 shows six worker nodes, a communications grid according to embodiments of the present technology may include more or less than six worker nodes. The number of worker nodes included in a communications grid may be dependent upon how large the project or data set is being processed by the communications grid, the capacity of each worker node, the time designated for the communications grid to complete the project, among others. Each worker node within the communications grid 400 may be connected (wired or wirelessly, and directly or indirectly) to control nodes 402-406. Therefore, each worker node may receive information from the control nodes (e.g., an instruction to perform work on a project) and may transmit information to the control nodes (e.g., a result from work performed on a project). Furthermore, worker nodes may communicate with each other (either directly or indirectly). For example, worker nodes may transmit data between each other related to a job being performed or an individual task within a job being performed by that worker node. However, in certain embodiments, worker nodes may not, for example, be connected (communicatively or otherwise) to certain other worker nodes. In an embodiment, worker nodes may only be able to communicate with the control node that controls it and may not be able to communicate with other worker nodes in the communications grid, whether they are other worker nodes controlled by the control node that controls the worker node, or worker nodes that are controlled by other control nodes in the communications grid.

A control node may connect with an external device with which the control node may communicate (e.g., a grid user, such as a server or computer, may connect to a controller of the grid). For example, a server or computer may connect to control nodes and may transmit a project or job to the node. The project may include a data set. The data set may be of any size. Once the control node receives such a project including a large data set, the control node may distribute the data set or projects related to the data set to be performed by worker nodes. Alternatively, for a project including a large data set, the data set may be received or stored by a machine other than a control node (e.g., a HADOOP® standard-compliant data node employing the HADOOP® Distributed File System, or HDFS).

Control nodes may maintain knowledge of the status of the nodes in the grid (i.e., grid status information), accept work requests from clients, subdivide the work across worker nodes, and coordinate the worker nodes, among other responsibilities. Worker nodes may accept work requests from a control node and provide the control node with results of the work performed by the worker node. A grid may be started from a single node (e.g., a machine, computer, server, etc.). This first node may be assigned or may start as the primary control node that will control any additional nodes that enter the grid.

When a project is submitted for execution (e.g., by a client or a controller of the grid) it may be assigned to a set of nodes. After the nodes are assigned to a project, a data structure (i.e., a communicator) may be created. The communicator may be used by the project for information to be shared between the project codes running on each node. A communication handle may be created on each node. A handle, for example, is a reference to the communicator that is valid within a single process on a single node, and the handle may be used when requesting communications between nodes.

A control node, such as control node 402, may be designated as the primary control node. A server, computer or other external device may connect to the primary control node. Once the control node receives a project, the primary control node may distribute portions of the project to its worker nodes for execution. For example, when a project is initiated on communications grid 400, primary control node 402 controls the work to be performed for the project in order to complete the project as requested or instructed. The primary control node may distribute work to the worker nodes based on various factors, such as which subsets or portions of projects may be completed most efficiently and in the correct amount of time. For example, a worker node may perform analysis on a portion of data that is already local (e.g., stored on) the worker node. The primary control node also coordinates and processes the results of the work performed by each worker node after each worker node executes and completes its job. For example, the primary control node may receive a result from one or more worker nodes, and the control node may organize (e.g., collect and assemble) the results received and compile them to produce a complete result for the project received from the end user.

Any remaining control nodes, such as control nodes 404 and 406, may be assigned as backup control nodes for the project. In an embodiment, backup control nodes may not control any portion of the project. Instead, backup control nodes may serve as a backup for the primary control node and take over as primary control node if the primary control node were to fail. If a communications grid were to include only a single control node, and the control node were to fail (e.g., the control node is shut off or breaks) then the communications grid as a whole may fail and any project or job being run on the communications grid may fail and may not complete. While the project may be run again, such a failure may cause a delay (severe delay in some cases, such as overnight delay) in completion of the project. Therefore, a grid with multiple control nodes, including a backup control node, may be beneficial.

To add another node or machine to the grid, the primary control node may open a pair of listening sockets, for example. A socket may be used to accept work requests from clients, and the second socket may be used to accept connections from other grid nodes. The primary control node may be provided with a list of other nodes (e.g., other machines, computers, servers) that will participate in the grid, and the role that each node will fill in the grid. Upon startup of the primary control node (e.g., the first node on the grid), the primary control node may use a network protocol to start the server process on every other node in the grid. Command line parameters, for example, may inform each node of one or more pieces of information, such as: the role that the node will have in the grid, the host name of the primary control node, the port number on which the primary control node is accepting connections from peer nodes, among others. The information may also be provided in a configuration file, transmitted over a secure shell tunnel, recovered from a configuration server, among others. While the other machines in the grid may not initially know about the configuration of the grid, that information may also be sent to each other node by the primary control node. Updates of the grid information may also be subsequently sent to those nodes.

For any control node other than the primary control node added to the grid, the control node may open three sockets. The first socket may accept work requests from clients, the second socket may accept connections from other grid members, and the third socket may connect (e.g., permanently) to the primary control node. When a control node (e.g., primary control node) receives a connection from another control node, it first checks to see if the peer node is in the list of configured nodes in the grid. If it is not on the list, the control node may clear the connection. If it is on the list, it may then attempt to authenticate the connection. If authentication is successful, the authenticating node may transmit information to its peer, such as the port number on which a node is listening for connections, the host name of the node, information about how to authenticate the node, among other information. When a node, such as the new control node, receives information about another active node, it will check to see if it already has a connection to that other node. If it does not have a connection to that node, it may then establish a connection to that control node.

Any worker node added to the grid may establish a connection to the primary control node and any other control nodes on the grid. After establishing the connection, it may authenticate itself to the grid (e.g., any control nodes, including both primary and backup, or a server or user controlling the grid). After successful authentication, the worker node may accept configuration information from the control node.

When a node joins a communications grid (e.g., when the node is powered on or connected to an existing node on the grid or both), the node is assigned (e.g., by an operating system of the grid) a universally unique identifier (UUID). This unique identifier may help other nodes and external entities (devices, users, etc.) to identify the node and distinguish it from other nodes. When a node is connected to the grid, the node may share its unique identifier with the other nodes in the grid. Since each node may share its unique identifier, each node may know the unique identifier of every other node on the grid. Unique identifiers may also designate a hierarchy of each of the nodes (e.g., backup control nodes) within the grid. For example, the unique identifiers of each of the backup control nodes may be stored in a list of backup control nodes to indicate an order in which the backup control nodes will take over for a failed primary control node to become a new primary control node. However, a hierarchy of nodes may also be determined using methods other than using the unique identifiers of the nodes. For example, the hierarchy may be predetermined or may be assigned based on other predetermined factors.

The grid may add new machines at any time (e.g., initiated from any control node). Upon adding a new node to the grid, the control node may first add the new node to its table of grid nodes. The control node may also then notify every other control node about the new node. The nodes receiving the notification may acknowledge that they have updated their configuration information.

Primary control node 402 may, for example, transmit one or more communications to backup control nodes 404 and 406 (and, for example, to other control or worker nodes within the communications grid). Such communications may be sent periodically, at fixed time intervals, between known fixed stages of the project's execution, among other protocols. The communications transmitted by primary control node 402 may be of varied types and may include a variety of types of information. For example, primary control node 402 may transmit snapshots (e.g., status information) of the communications grid so that backup control node 404 always has a recent snapshot of the communications grid. The snapshot or grid status may include, for example, the structure of the grid (including, for example, the worker nodes in the grid, unique identifiers of the nodes, or their relationships with the primary control node) and the status of a project (including, for example, the status of each worker node's portion of the project). The snapshot may also include analysis or results received from worker nodes in the communications grid. The backup control nodes may receive and store the backup data received from the primary control node. The backup control nodes may transmit a request for such a snapshot (or other information) from the primary control node, or the primary control node may send such information periodically to the backup control nodes.

As noted, the backup data may allow the backup control node to take over as primary control node if the primary control node fails without requiring the grid to start the project over from scratch. If the primary control node fails, the backup control node that will take over as primary control node may retrieve the most recent version of the snapshot received from the primary control node and use the snapshot to continue the project from the stage of the project indicated by the backup data. This may prevent failure of the project as a whole.

A backup control node may use various methods to determine that the primary control node has failed. In one example of such a method, the primary control node may transmit (e.g., periodically) a communication to the backup control node that indicates that the primary control node is working and has not failed, such as a heartbeat communication. The backup control node may determine that the primary control node has failed if the backup control node has not received a heartbeat communication for a certain predetermined period of time. Alternatively, a backup control node may also receive a communication from the primary control node itself (before it failed) or from a worker node that the primary control node has failed, for example because the primary control node has failed to communicate with the worker node.

Different methods may be performed to determine which backup control node of a set of backup control nodes (e.g., backup control nodes 404 and 406) will take over for failed primary control node 402 and become the new primary control node. For example, the new primary control node may be chosen based on a ranking or “hierarchy” of backup control nodes based on their unique identifiers. In an alternative embodiment, a backup control node may be assigned to be the new primary control node by another device in the communications grid or from an external device (e.g., a system infrastructure or an end user, such as a server or computer, controlling the communications grid). In another alternative embodiment, the backup control node that takes over as the new primary control node may be designated based on bandwidth or other statistics about the communications grid.

A worker node within the communications grid may also fail. If a worker node fails, work being performed by the failed worker node may be redistributed amongst the operational worker nodes. In an alternative embodiment, the primary control node may transmit a communication to each of the operable worker nodes still on the communications grid that each of the worker nodes should purposefully fail also. After each of the worker nodes fail, they may each retrieve their most recently saved checkpoint of their status and re-start the project from that checkpoint to minimize lost progress on the project being executed.

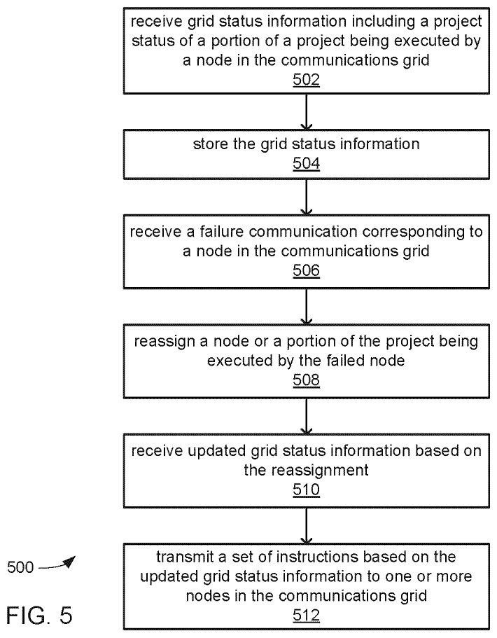

FIG. 5 illustrates a flow chart showing an example process 500 for adjusting a communications grid or a work project in a communications grid after a failure of a node, according to embodiments of the present technology. The process may include, for example, receiving grid status information including a project status of a portion of a project being executed by a node in the communications grid, as described in operation 502. For example, a control node (e.g., a backup control node connected to a primary control node and a worker node on a communications grid) may receive grid status information, where the grid status information includes a project status of the primary control node or a project status of the worker node. The project status of the primary control node and the project status of the worker node may include a status of one or more portions of a project being executed by the primary and worker nodes in the communications grid. The process may also include storing the grid status information, as described in operation 504. For example, a control node (e.g., a backup control node) may store the received grid status information locally within the control node. Alternatively, the grid status information may be sent to another device for storage where the control node may have access to the information.

The process may also include receiving a failure communication corresponding to a node in the communications grid in operation 506. For example, a node may receive a failure communication including an indication that the primary control node has failed, prompting a backup control node to take over for the primary control node. In an alternative embodiment, a node may receive a failure that a worker node has failed, prompting a control node to reassign the work being performed by the worker node. The process may also include reassigning a node or a portion of the project being executed by the failed node, as described in operation 508. For example, a control node may designate the backup control node as a new primary control node based on the failure communication upon receiving the failure communication. If the failed node is a worker node, a control node may identify a project status of the failed worker node using the snapshot of the communications grid, where the project status of the failed worker node includes a status of a portion of the project being executed by the failed worker node at the failure time.

The process may also include receiving updated grid status information based on the reassignment, as described in operation 510, and transmitting a set of instructions based on the updated grid status information to one or more nodes in the communications grid, as described in operation 512. The updated grid status information may include an updated project status of the primary control node or an updated project status of the worker node. The updated information may be transmitted to the other nodes in the grid to update their stale stored information.

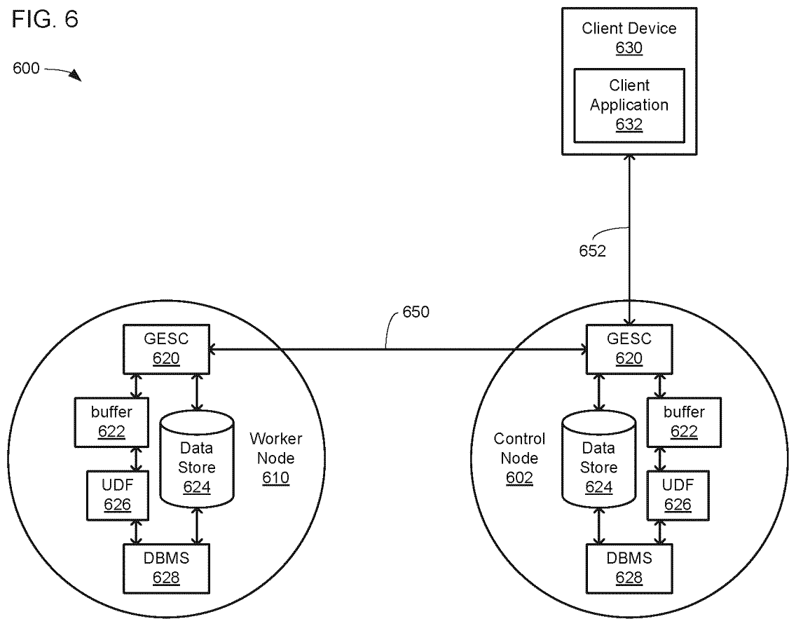

FIG. 6 illustrates a portion of a communications grid computing system 600 including a control node and a worker node, according to embodiments of the present technology. Communications grid 600 computing system includes one control node (control node 602) and one worker node (worker node 610) for purposes of illustration but may include more worker and/or control nodes. The control node 602 is communicatively connected to worker node 610 via communication path 650. Therefore, control node 602 may transmit information (e.g., related to the communications grid or notifications), to and receive information from worker node 610 via path 650.

Similar to in FIG. 4, communications grid computing system (or just “communications grid”) 600 includes data processing nodes (control node 602 and worker node 610). Nodes 602 and 610 include multi-core data processors. Each node 602 and 610 includes a grid-enabled software component (GESC) 620 that executes on the data processor associated with that node and interfaces with buffer memory 622 also associated with that node. Each node 602 and 610 includes database management software (DBMS) 628 that executes on a database server (not shown) at control node 602 and on a database server (not shown) at worker node 610.

Each node also includes a data store 624. Data stores 624, similar to network-attached data stores 110 in FIG. 1 and data stores 235 in FIG. 2, are used to store data to be processed by the nodes in the computing environment. Data stores 624 may also store any intermediate or final data generated by the computing system after being processed, for example in non-volatile memory. However, in certain embodiments, the configuration of the grid computing environment allows its operations to be performed such that intermediate and final data results can be stored solely in volatile memory (e.g., RAM), without a requirement that intermediate or final data results be stored to non-volatile types of memory. Storing such data in volatile memory may be useful in certain situations, such as when the grid receives queries (e.g., ad hoc) from a client and when responses, which are generated by processing large amounts of data, need to be generated quickly or on-the-fly. In such a situation, the grid may be configured to retain the data within memory so that responses can be generated at different levels of detail and so that a client may interactively query against this information.

Each node also includes a user-defined function (UDF) 626. The UDF provides a mechanism for the DBMS 628 to transfer data to or receive data from the database stored in the data stores 624 that are managed by the DBMS. For example, UDF 626 can be invoked by the DBMS to provide data to the GESC for processing. The UDF 626 may establish a socket connection (not shown) with the GESC to transfer the data. Alternatively, the UDF 626 can transfer data to the GESC by writing data to shared memory accessible by both the UDF and the GESC.

The GESC 620 at the nodes 602 and 620 may be connected via a network, such as network 108 shown in FIG. 1. Therefore, nodes 602 and 620 can communicate with each other via the network using a predetermined communication protocol such as, for example, the Message Passing Interface (MPI). Each GESC 620 can engage in point-to-point communication with the GESC at another node or in collective communication with multiple GESCs via the network. The GESC 620 at each node may contain identical (or nearly identical) software instructions. Each node may be capable of operating as either a control node or a worker node. The GESC at the control node 602 can communicate, over a communication path 652, with a client device 630. More specifically, control node 602 may communicate with client application 632 hosted by the client device 630 to receive queries and to respond to those queries after processing large amounts of data.

DBMS 628 may control the creation, maintenance, and use of database or data structure (not shown) within a node 602 or 610. The database may organize data stored in data stores 624. The DBMS 628 at control node 602 may accept requests for data and transfer the appropriate data for the request. With such a process, collections of data may be distributed across multiple physical locations. In this example, each node 602 and 610 stores a portion of the total data managed by the management system in its associated data store 624.

Furthermore, the DBMS may be responsible for protecting against data loss using replication techniques. Replication includes providing a backup copy of data stored on one node on one or more other nodes. Therefore, if one node fails, the data from the failed node can be recovered from a replicated copy residing at another node. However, as described herein with respect to FIG. 4, data or status information for each node in the communications grid may also be shared with each node on the grid.

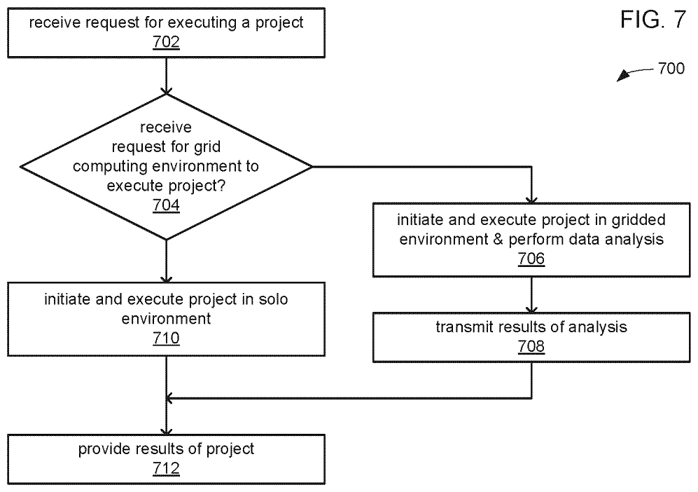

FIG. 7 illustrates a flow chart showing an example method 700 for executing a project within a grid computing system, according to embodiments of the present technology. As described with respect to FIG. 6, the GESC at the control node may transmit data with a client device (e.g., client device 630) to receive queries for executing a project and to respond to those queries after large amounts of data have been processed. The query may be transmitted to the control node, where the query may include a request for executing a project, as described in operation 702. The query can contain instructions on the type of data analysis to be performed in the project and whether the project should be executed using the grid-based computing environment, as shown in operation 704.

To initiate the project, the control node may determine if the query requests use of the grid-based computing environment to execute the project. If the determination is no, then the control node initiates execution of the project in a solo environment (e.g., at the control node), as described in operation 710. If the determination is yes, the control node may initiate execution of the project in the grid-based computing environment, as described in operation 706. In such a situation, the request may include a requested configuration of the grid. For example, the request may include a number of control nodes and a number of worker nodes to be used in the grid when executing the project. After the project has been completed, the control node may transmit results of the analysis yielded by the grid, as described in operation 708. Whether the project is executed in a solo or grid-based environment, the control node provides the results of the project, as described in operation 712.

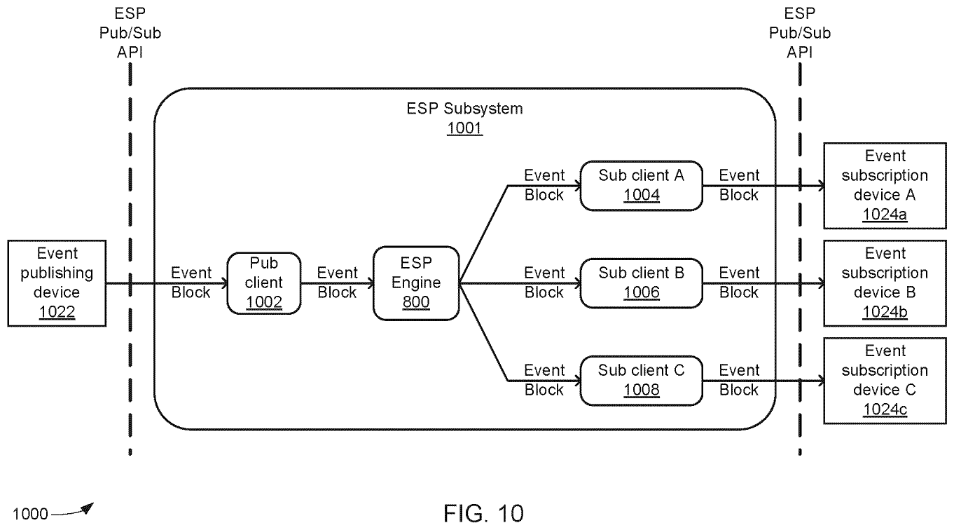

As noted with respect to FIG. 2, the computing environments described herein may collect data (e.g., as received from network devices, such as sensors, such as network devices 204-209 in FIG. 2, and client devices or other sources) to be processed as part of a data analytics project, and data may be received in real time as part of a streaming analytics environment (e.g., ESP). Data may be collected using a variety of sources as communicated via different kinds of networks or locally, such as on a real-time streaming basis. For example, network devices may receive data periodically from network device sensors as the sensors continuously sense, monitor and track changes in their environments. More specifically, an increasing number of distributed applications develop or produce continuously flowing data from distributed sources by applying queries to the data before distributing the data to geographically distributed recipients. An event stream processing engine (ESPE) may continuously apply the queries to the data as it is received and determines which entities should receive the data. Clients or other devices may also subscribe to the ESPE or other devices processing ESP data so that they can receive data after processing, based on for example the entities determined by the processing engine. For example, client devices 230 in FIG. 2 may subscribe to the ESPE in computing environment 214. In another example, event subscription devices 1024a-c, described further with respect to FIG. 10, may also subscribe to the ESPE. The ESPE may determine or define how input data or event streams from network devices or other publishers (e.g., network devices 204-209 in FIG. 2) are transformed into meaningful output data to be consumed by subscribers, such as for example client devices 230 in FIG. 2.

FIG. 8 illustrates a block diagram including components of an Event Stream Processing Engine (ESPE), according to embodiments of the present technology. ESPE 800 may include one or more projects 802. A project may be described as a second-level container in an engine model managed by ESPE 800 where a thread pool size for the project may be defined by a user. Each project of the one or more projects 802 may include one or more continuous queries 804 that contain data flows, which are data transformations of incoming event streams. The one or more continuous queries 804 may include one or more source windows 806 and one or more derived windows 808.

The ESPE may receive streaming data over a period of time related to certain events, such as events or other data sensed by one or more network devices. The ESPE may perform operations associated with processing data created by the one or more devices. For example, the ESPE may receive data from the one or more network devices 204-209 shown in FIG. 2. As noted, the network devices may include sensors that sense different aspects of their environments and may collect data over time based on those sensed observations. For example, the ESPE may be implemented within one or more of machines 220 and 240 shown in FIG. 2. The ESPE may be implemented within such a machine by an ESP application. An ESP application may embed an ESPE with its own dedicated thread pool or pools into its application space where the main application thread can do application-specific work and the ESPE processes event streams at least by creating an instance of a model into processing objects.

The engine container is the top-level container in a model that manages the resources of the one or more projects 802. In an illustrative embodiment, for example, there may be only one ESPE 800 for each instance of the ESP application, and ESPE 800 may have a unique engine name. Additionally, the one or more projects 802 may each have unique project names, and each query may have a unique continuous query name and begin with a uniquely named source window of the one or more source windows 806. ESPE 800 may or may not be persistent.

Continuous query modeling involves defining directed graphs of windows for event stream manipulation and transformation. A window in the context of event stream manipulation and transformation is a processing node in an event stream processing model. A window in a continuous query can perform aggregations, computations, pattern-matching, and other operations on data flowing through the window. A continuous query may be described as a directed graph of source, relational, pattern matching, and procedural windows. The one or more source windows 806 and the one or more derived windows 808 represent continuously executing queries that generate updates to a query result set as new event blocks stream through ESPE 800. A directed graph, for example, is a set of nodes connected by edges, where the edges have a direction associated with them.

An event object may be described as a packet of data accessible as a collection of fields, with at least one of the fields defined as a key or unique identifier (ID). The event object may be created using a variety of formats including binary, alphanumeric, XML, etc. Each event object may include one or more fields designated as a primary identifier (ID) for the event so ESPE 800 can support operation codes (opcodes) for events including insert, update, upsert, and delete. Upsert opcodes update the event if the key field already exists; otherwise, the event is inserted. For illustration, an event object may be a packed binary representation of a set of field values and include both metadata and field data associated with an event. The metadata may include an opcode indicating if the event represents an insert, update, delete, or upsert, a set of flags indicating if the event is a normal, partial-update, or a retention generated event from retention policy management, and a set of microsecond timestamps that can be used for latency measurements.

An event block object may be described as a grouping or package of event objects. An event stream may be described as a flow of event block objects. A continuous query of the one or more continuous queries 804 transforms a source event stream made up of streaming event block objects published into ESPE 800 into one or more output event streams using the one or more source windows 806 and the one or more derived windows 808. A continuous query can also be thought of as data flow modeling.

The one or more source windows 806 are at the top of the directed graph and have no windows feeding into them. Event streams are published into the one or more source windows 806, and from there, the event streams may be directed to the next set of connected windows as defined by the directed graph. The one or more derived windows 808 are all instantiated windows that are not source windows and that have other windows streaming events into them. The one or more derived windows 808 may perform computations or transformations on the incoming event streams. The one or more derived windows 808 transform event streams based on the window type (that is operators such as join, filter, compute, aggregate, copy, pattern match, procedural, union, etc.) and window settings. As event streams are published into ESPE 800, they are continuously queried, and the resulting sets of derived windows in these queries are continuously updated.

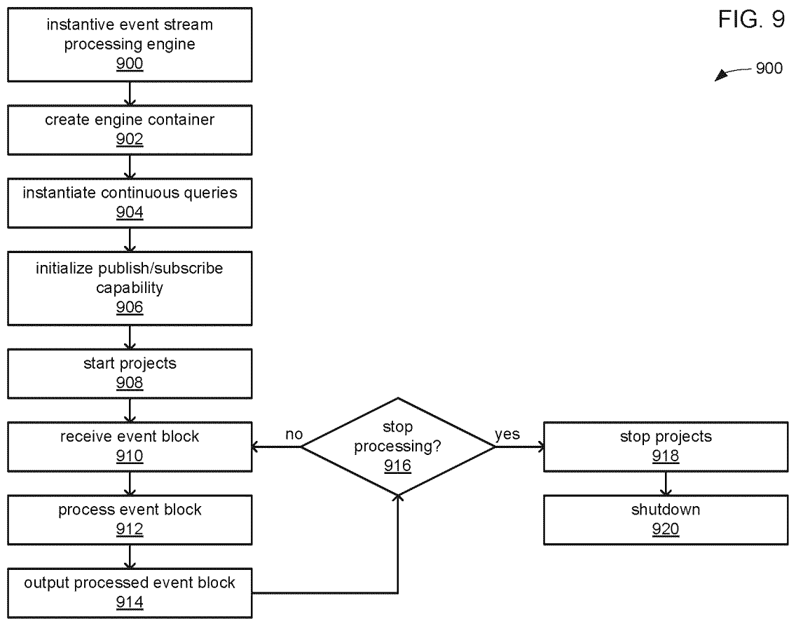

FIG. 9 illustrates a flow chart showing an example process including operations performed by an event stream processing engine, according to some embodiments of the present technology. As noted, the ESPE 800 (or an associated ESP application) defines how input event streams are transformed into meaningful output event streams. More specifically, the ESP application may define how input event streams from publishers (e.g., network devices providing sensed data) are transformed into meaningful output event streams consumed by subscribers (e.g., a data analytics project being executed by a machine or set of machines).

Within the application, a user may interact with one or more user interface windows presented to the user in a display under control of the ESPE independently or through a browser application in an order selectable by the user. For example, a user may execute an ESP application, which causes presentation of a first user interface window, which may include a plurality of menus and selectors such as drop down menus, buttons, text boxes, hyperlinks, etc. associated with the ESP application as understood by a person of skill in the art. As further understood by a person of skill in the art, various operations may be performed in parallel, for example, using a plurality of threads.

At operation 900, an ESP application may define and start an ESPE, thereby instantiating an ESPE at a device, such as machine 220 and/or 240. In an operation 902, the engine container is created. For illustration, ESPE 800 may be instantiated using a function call that specifies the engine container as a manager for the model.

In an operation 904, the one or more continuous queries 804 are instantiated by ESPE 800 as a model. The one or more continuous queries 804 may be instantiated with a dedicated thread pool or pools that generate updates as new events stream through ESPE 800. For illustration, the one or more continuous queries 804 may be created to model business processing logic within ESPE 800, to predict events within ESPE 800, to model a physical system within ESPE 800, to predict the physical system state within ESPE 800, etc. For example, as noted, ESPE 800 may be used to support sensor data monitoring and management (e.g., sensing may include force, torque, load, strain, position, temperature, air pressure, fluid flow, chemical properties, resistance, electromagnetic fields, radiation, irradiance, proximity, acoustics, moisture, distance, speed, vibrations, acceleration, electrical potential, or electrical current, etc.).

ESPE 800 may analyze and process events in motion or “event streams.” Instead of storing data and running queries against the stored data, ESPE 800 may store queries and stream data through them to allow continuous analysis of data as it is received. The one or more source windows 806 and the one or more derived windows 808 may be created based on the relational, pattern matching, and procedural algorithms that transform the input event streams into the output event streams to model, simulate, score, test, predict, etc. based on the continuous query model defined and application to the streamed data.

In an operation 906, a publish/subscribe (pub/sub) capability is initialized for ESPE 800. In an illustrative embodiment, a pub/sub capability is initialized for each project of the one or more projects 802. To initialize and enable pub/sub capability for ESPE 800, a port number may be provided. Pub/sub clients can use a host name of an ESP device running the ESPE and the port number to establish pub/sub connections to ESPE 800.

FIG. 10 illustrates an ESP system 1000 interfacing between publishing device 1022 and event subscribing devices 1024a-c, according to embodiments of the present technology. ESP system 1000 may include ESP device or subsystem 851, event publishing device 1022, an event subscribing device A 1024a, an event subscribing device B 1024b, and an event subscribing device C 1024c. Input event streams are output to ESP device 851 by publishing device 1022. In alternative embodiments, the input event streams may be created by a plurality of publishing devices. The plurality of publishing devices further may publish event streams to other ESP devices. The one or more continuous queries instantiated by ESPE 800 may analyze and process the input event streams to form output event streams output to event subscribing device A 1024a, event subscribing device B 1024b, and event subscribing device C 1024c. ESP system 1000 may include a greater or a fewer number of event subscribing devices of event subscribing devices.

Publish-subscribe is a message-oriented interaction paradigm based on indirect addressing. Processed data recipients specify their interest in receiving information from ESPE 800 by subscribing to specific classes of events, while information sources publish events to ESPE 800 without directly addressing the receiving parties. ESPE 800 coordinates the interactions and processes the data. In some cases, the data source receives confirmation that the published information has been received by a data recipient.

A publish/subscribe API may be described as a library that enables an event publisher, such as publishing device 1022, to publish event streams into ESPE 800 or an event subscriber, such as event subscribing device A 1024a, event subscribing device B 1024b, and event subscribing device C 1024c, to subscribe to event streams from ESPE 800. For illustration, one or more publish/subscribe APIs may be defined. Using the publish/subscribe API, an event publishing application may publish event streams into a running event stream processor project source window of ESPE 800, and the event subscription application may subscribe to an event stream processor project source window of ESPE 800.

The publish/subscribe API provides cross-platform connectivity and endianness compatibility between ESP application and other networked applications, such as event publishing applications instantiated at publishing device 1022, and event subscription applications instantiated at one or more of event subscribing device A 1024a, event subscribing device B 1024b, and event subscribing device C 1024c.

Referring back to FIG. 9, operation 906 initializes the publish/subscribe capability of ESPE 800. In an operation 908, the one or more projects 802 are started. The one or more started projects may run in the background on an ESP device. In an operation 910, an event block object is received from one or more computing devices of the event publishing device 1022.

ESP subsystem 800 may include a publishing client 1002, ESPE 800, a subscribing client A 1004, a subscribing client B 1006, and a subscribing client C 1008. Publishing client 1002 may be started by an event publishing application executing at publishing device 1022 using the publish/subscribe API. Subscribing client A 1004 may be started by an event subscription application A, executing at event subscribing device A 1024a using the publish/subscribe API. Subscribing client B 1006 may be started by an event subscription application B executing at event subscribing device B 1024b using the publish/subscribe API. Subscribing client C 1008 may be started by an event subscription application C executing at event subscribing device C 1024c using the publish/subscribe API.

An event block object containing one or more event objects is injected into a source window of the one or more source windows 806 from an instance of an event publishing application on event publishing device 1022. The event block object may be generated, for example, by the event publishing application and may be received by publishing client 1002. A unique ID may be maintained as the event block object is passed between the one or more source windows 806 and/or the one or more derived windows 808 of ESPE 800, and to subscribing client A 1004, subscribing client B 1006, and subscribing client C 1008 and to event subscription device A 1024a, event subscription device B 1024b, and event subscription device C 1024c. Publishing client 1002 may further generate and include a unique embedded transaction ID in the event block object as the event block object is processed by a continuous query, as well as the unique ID that publishing device 1022 assigned to the event block object.

In an operation 912, the event block object is processed through the one or more continuous queries 804. In an operation 914, the processed event block object is output to one or more computing devices of the event subscribing devices 1024a-c. For example, subscribing client A 1004, subscribing client B 1006, and subscribing client C 1008 may send the received event block object to event subscription device A 1024a, event subscription device B 1024b, and event subscription device C 1024c, respectively.

ESPE 800 maintains the event block containership aspect of the received event blocks from when the event block is published into a source window and works its way through the directed graph defined by the one or more continuous queries 804 with the various event translations before being output to subscribers. Subscribers can correlate a group of subscribed events back to a group of published events by comparing the unique ID of the event block object that a publisher, such as publishing device 1022, attached to the event block object with the event block ID received by the subscriber.

In an operation 916, a determination is made concerning whether or not processing is stopped. If processing is not stopped, processing continues in operation 910 to continue receiving the one or more event streams containing event block objects from the, for example, one or more network devices. If processing is stopped, processing continues in an operation 918. In operation 918, the started projects are stopped. In operation 920, the ESPE is shutdown.

As noted, in some embodiments, big data is processed for an analytics project after the data is received and stored. In other embodiments, distributed applications process continuously flowing data in real-time from distributed sources by applying queries to the data before distributing the data to geographically distributed recipients. As noted, an event stream processing engine (ESPE) may continuously apply the queries to the data as it is received and determines which entities receive the processed data. This allows for large amounts of data being received and/or collected in a variety of environments to be processed and distributed in real time. For example, as shown with respect to FIG. 2, data may be collected from network devices that may include devices within the internet of things, such as devices within a home automation network. However, such data may be collected from a variety of different resources in a variety of different environments. In any such situation, embodiments of the present technology allow for real-time processing of such data.

Aspects of the current disclosure provide technical solutions to technical problems, such as computing problems that arise when an ESP device fails which results in a complete service interruption and potentially significant data loss. The data loss can be catastrophic when the streamed data is supporting mission critical operations such as those in support of an ongoing manufacturing or drilling operation. An embodiment of an ESP system achieves a rapid and seamless failover of ESPE running at the plurality of ESP devices without service interruption or data loss, thus significantly improving the reliability of an operational system that relies on the live or real-time processing of the data streams. The event publishing systems, the event subscribing systems, and each ESPE not executing at a failed ESP device are not aware of or effected by the failed ESP device. The ESP system may include thousands of event publishing systems and event subscribing systems. The ESP system keeps the failover logic and awareness within the boundaries of out-messaging network connector and out-messaging network device.

In one example embodiment, a system is provided to support a failover when event stream processing (ESP) event blocks. The system includes, but is not limited to, an out-messaging network device and a computing device. The computing device includes, but is not limited to, a processor and a computer-readable medium operably coupled to the processor. The processor is configured to execute an ESP engine (ESPE). The computer-readable medium has instructions stored thereon that, when executed by the processor, cause the computing device to support the failover. An event block object is received from the ESPE that includes a unique identifier. A first status of the computing device as active or standby is determined. When the first status is active, a second status of the computing device as newly active or not newly active is determined. Newly active is determined when the computing device is switched from a standby status to an active status. When the second status is newly active, a last published event block object identifier that uniquely identifies a last published event block object is determined. A next event block object is selected from a non-transitory computer-readable medium accessible by the computing device. The next event block object has an event block object identifier that is greater than the determined last published event block object identifier. The selected next event block object is published to an out-messaging network device. When the second status of the computing device is not newly active, the received event block object is published to the out-messaging network device. When the first status of the computing device is standby, the received event block object is stored in the non-transitory computer-readable medium.

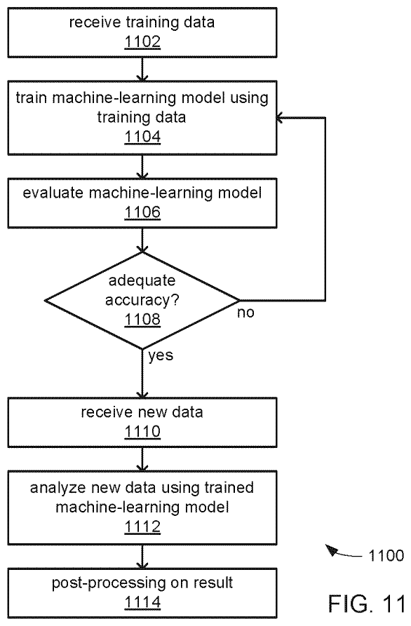

FIG. 11 is a flow chart of an example of a process for generating and using a machine-learning model according to some aspects. Machine learning is a branch of artificial intelligence that relates to mathematical models that can learn from, categorize, and make predictions about data. Such mathematical models, which can be referred to as machine-learning models, can classify input data among two or more classes; cluster input data among two or more groups; predict a result based on input data; identify patterns or trends in input data; identify a distribution of input data in a space; or any combination of these. Examples of machine-learning models can include (i) neural networks; (ii) decision trees, such as classification trees and regression trees; (iii) classifiers, such as Naïve bias classifiers, logistic regression classifiers, ridge regression classifiers, random forest classifiers, least absolute shrinkage and selector (LASSO) classifiers, and support vector machines; (iv) clusterers, such as k-means clusterers, mean-shift clusterers, and spectral clusterers; (v) factorizers, such as factorization machines, principal component analyzers and kernel principal component analyzers; and (vi) ensembles or other combinations of machine-learning models. In some examples, neural networks can include deep neural networks, feed-forward neural networks, recurrent neural networks, convolutional neural networks, radial basis function (RBF) neural networks, echo state neural networks, long short-term memory neural networks, bi-directional recurrent neural networks, gated neural networks, hierarchical recurrent neural networks, stochastic neural networks, modular neural networks, spiking neural networks, dynamic neural networks, cascading neural networks, neuro-fuzzy neural networks, or any combination of these.

Different machine-learning models may be used interchangeably to perform a task. Examples of tasks that can be performed at least partially using machine-learning models include various types of scoring; bioinformatics; cheminformatics; software engineering; fraud detection; customer segmentation; generating online recommendations; adaptive websites; determining customer lifetime value; search engines; placing advertisements in real time or near real time; classifying DNA sequences; affective computing; performing natural language processing and understanding; object recognition and computer vision; robotic locomotion; playing games; optimization and metaheuristics; detecting network intrusions; medical diagnosis and monitoring; or predicting when an asset, such as a machine, will need maintenance.

Any number and combination of tools can be used to create machine-learning models. Examples of tools for creating and managing machine-learning models can include SAS® Enterprise Miner, SAS® Rapid Predictive Modeler, and SAS® Model Manager, SAS Cloud Analytic Services (CAS)®, SAS Viya® of all which are by SAS Institute Inc. of Cary, North Carolina.

Machine-learning models can be constructed through an at least partially automated (e.g., with little or no human involvement) process called training. During training, input data can be iteratively supplied to a machine-learning model to enable the machine-learning model to identify patterns related to the input data or to identify relationships between the input data and output data. With training, the machine-learning model can be transformed from an untrained state to a trained state. Input data can be split into one or more training sets and one or more validation sets, and the training process may be repeated multiple times. The splitting may follow a k-fold cross-validation rule, a leave-one-out-rule, a leave-p-out rule, or a holdout rule. An overview of training and using a machine-learning model is described below with respect to the flow chart of FIG. 11.

In block 1102, training data is received. In some examples, the training data is received from a remote database or a local database, constructed from various subsets of data, or input by a user. The training data can be used in its raw form for training a machine-learning model or pre-processed into another form, which can then be used for training the machine-learning model. For example, the raw form of the training data can be smoothed, truncated, aggregated, clustered, or otherwise manipulated into another form, which can then be used for training the machine-learning model.

In block 1104, a machine-learning model is trained using the training data. The machine-learning model can be trained in a supervised, unsupervised, or semi-supervised manner. In supervised training, each input in the training data is correlated to a desired output. This desired output may be a scalar, a vector, or a different type of data structure such as text or an image. This may enable the machine-learning model to learn a mapping between the inputs and desired outputs. In unsupervised training, the training data includes inputs, but not desired outputs, so that the machine-learning model has to find structure in the inputs on its own. In semi-supervised training, only some of the inputs in the training data are correlated to desired outputs.

In block 1106, the machine-learning model is evaluated. For example, an evaluation dataset can be obtained, for example, via user input or from a database. The evaluation dataset can include inputs correlated to desired outputs. The inputs can be provided to the machine-learning model and the outputs from the machine-learning model can be compared to the desired outputs. If the outputs from the machine-learning model closely correspond with the desired outputs, the machine-learning model may have a high degree of accuracy. For example, if 90% or more of the outputs from the machine-learning model are the same as the desired outputs in the evaluation dataset, the machine-learning model may have a high degree of accuracy. Otherwise, the machine-learning model may have a low degree of accuracy. The 90% number is an example only. A realistic and desirable accuracy percentage is dependent on the problem and the data.

In some examples, if, at 1108, the machine-learning model has an inadequate degree of accuracy for a particular task, the process can return to block 1104, where the machine-learning model can be further trained using additional training data or otherwise modified to improve accuracy. However, if, at 1108. the machine-learning model has an adequate degree of accuracy for the particular task, the process can continue to block 1110.

In block 1110, new data is received. In some examples, the new data is received from a remote database or a local database, constructed from various subsets of data, or input by a user. The new data may be unknown to the machine-learning model. For example, the machine-learning model may not have previously processed or analyzed the new data.

In block 1112, the trained machine-learning model is used to analyze the new data and provide a result. For example, the new data can be provided as input to the trained machine-learning model. The trained machine-learning model can analyze the new data and provide a result that includes a classification of the new data into a particular class, a clustering of the new data into a particular group, a prediction based on the new data, or any combination of these.

In block 1114, the result is post-processed. For example, the result can be added to, multiplied with, or otherwise combined with other data as part of a job. As another example, the result can be transformed from a first format, such as a time series format, into another format, such as a count series format. Any number and combination of operations can be performed on the result during post-processing.

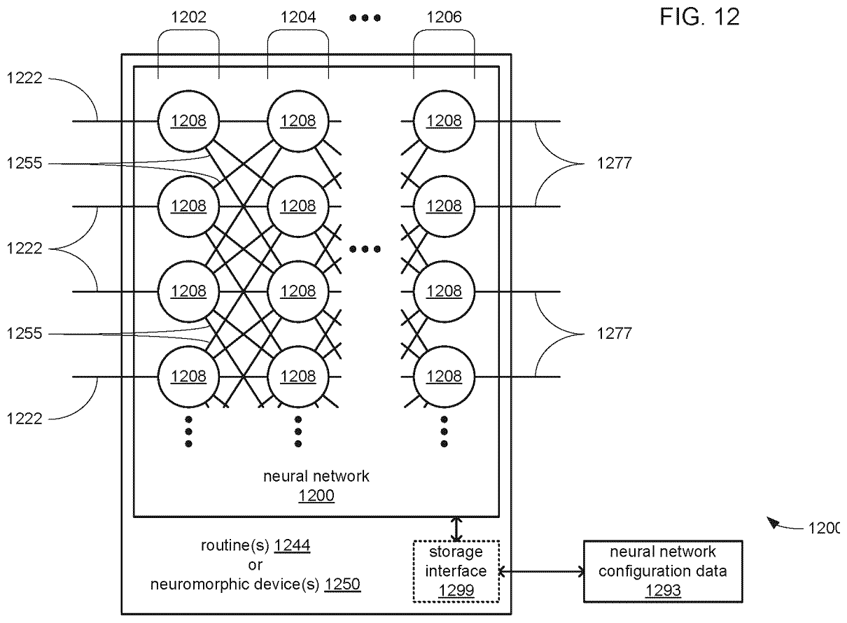

A more specific example of a machine-learning model is the neural network 1200 shown in FIG. 12. The neural network 1200 is represented as multiple layers of neurons 1208 that can exchange data between one another via connections 1255 that may be selectively instantiated thereamong. The layers include an input layer 1202 for receiving input data provided at inputs 1222, one or more hidden layers 1204, and an output layer 1206 for providing a result at outputs 1277. The hidden layer(s) 1204 are referred to as hidden because they may not be directly observable or have their inputs or outputs directly accessible during the normal functioning of the neural network 1200. Although the neural network 1200 is shown as having a specific number of layers and neurons for exemplary purposes, the neural network 1200 can have any number and combination of layers, and each layer can have any number and combination of neurons.

The neurons 1208 and connections 1255 thereamong may have numeric weights, which can be tuned during training of the neural network 1200. For example, training data can be provided to at least the inputs 1222 to the input layer 1202 of the neural network 1200, and the neural network 1200 can use the training data to tune one or more numeric weights of the neural network 1200. In some examples, the neural network 1200 can be trained using backpropagation. Backpropagation can include determining a gradient of a particular numeric weight based on a difference between an actual output of the neural network 1200 at the outputs 1277 and a desired output of the neural network 1200. Based on the gradient, one or more numeric weights of the neural network 1200 can be updated to reduce the difference therebetween, thereby increasing the accuracy of the neural network 1200. This process can be repeated multiple times to train the neural network 1200. For example, this process can be repeated hundreds or thousands of times to train the neural network 1200.

In some examples, the neural network 1200 is a feed-forward neural network. In a feed-forward neural network, the connections 1255 are instantiated and/or weighted so that every neuron 1208 only propagates an output value to a subsequent layer of the neural network 1200. For example, data may only move one direction (forward) from one neuron 1208 to the next neuron 1208 in a feed-forward neural network. Such a “forward” direction may be defined as proceeding from the input layer 1202 through the one or more hidden layers 1204, and toward the output layer 1206.

In other examples, the neural network 1200 may be a recurrent neural network. A recurrent neural network can include one or more feedback loops among the connections 1255, thereby allowing data to propagate in both forward and backward through the neural network 1200. Such a “backward” direction may be defined as proceeding in the opposite direction of forward, such as from the output layer 1206 through the one or more hidden layers 1204, and toward the input layer 1202. This can allow for information to persist within the recurrent neural network. For example, a recurrent neural network can determine an output based at least partially on information that the recurrent neural network has seen before, giving the recurrent neural network the ability to use previous input to inform the output.

In some examples, the neural network 1200 operates by receiving a vector of numbers from one layer; transforming the vector of numbers into a new vector of numbers using a matrix of numeric weights, a nonlinearity, or both; and providing the new vector of numbers to a subsequent layer (“subsequent” in the sense of moving “forward”) of the neural network 1200. Each subsequent layer of the neural network 1200 can repeat this process until the neural network 1200 outputs a final result at the outputs 1277 of the output layer 1206. For example, the neural network 1200 can receive a vector of numbers at the inputs 1222 of the input layer 1202. The neural network 1200 can multiply the vector of numbers by a matrix of numeric weights to determine a weighted vector. The matrix of numeric weights can be tuned during the training of the neural network 1200. The neural network 1200 can transform the weighted vector using a nonlinearity, such as a sigmoid tangent or the hyperbolic tangent. In some examples, the nonlinearity can include a rectified linear unit, which can be expressed using the equation y=max (x, 0) where y is the output and x is an input value from the weighted vector. The transformed output can be supplied to a subsequent layer (e.g., a hidden layer 1204) of the neural network 1200. The subsequent layer of the neural network 1200 can receive the transformed output, multiply the transformed output by a matrix of numeric weights and a nonlinearity, and provide the result to yet another layer of the neural network 1200 (e.g., another, subsequent, hidden layer 1204). This process continues until the neural network 1200 outputs a final result at the outputs 1277 of the output layer 1206.

As also depicted in FIG. 12, the neural network 1200 may be implemented either through the execution of the instructions of one or more routines 1244 by central processing units (CPUs), or through the use of one or more neuromorphic devices 1250 that incorporate a set of memristors (or other similar components) that each function to implement one of the neurons 1208 in hardware. Where multiple neuromorphic devices 1250 are used, they may be interconnected in a depth-wise manner to enable implementing neural networks with greater quantities of layers, and/or in a width-wise manner to enable implementing neural networks having greater quantities of neurons 1208 per layer.

The neuromorphic device 1250 may incorporate a storage interface 1299 by which neural network configuration data 1293 that is descriptive of various parameters and hyper parameters of the neural network 1200 may be stored and/or retrieved. More specifically, the neural network configuration data 1293 may include such parameters as weighting and/or biasing values derived through the training of the neural network 1200, as has been described. Alternatively, or additionally, the neural network configuration data 1293 may include such hyperparameters as the manner in which the neurons 1208 are to be interconnected (e.g., feed-forward or recurrent), the trigger function to be implemented within the neurons 1208, the quantity of layers and/or the overall quantity of the neurons 1208. The neural network configuration data 1293 may provide such information for more than one neuromorphic device 1250 where multiple ones have been interconnected to support larger neural networks.

Other examples of the present disclosure may include any number and combination of machine-learning models having any number and combination of characteristics. The machine-learning model(s) can be trained in a supervised, semi-supervised, or unsupervised manner, or any combination of these. The machine-learning model(s) can be implemented using a single computing device or multiple computing devices, such as the communications grid computing system 400 discussed above.

Implementing some examples of the present disclosure at least in part by using machine-learning models can reduce the total number of processing iterations, time, memory, electrical power, or any combination of these consumed by a computing device when analyzing data. For example, a neural network may more readily identify patterns in data than other approaches. This may enable the neural network to analyze the data using fewer processing cycles and less memory than other approaches, while obtaining a similar or greater level of accuracy.

Some machine-learning approaches may be more efficiently and speedily executed and processed with machine-learning specific processors (e.g., not a generic CPU). Such processors may also provide an energy savings when compared to generic CPUs. For example, some of these processors can include a graphical processing unit (GPU), an application-specific integrated circuit (ASIC), a field-programmable gate array (FPGA), an artificial intelligence (AI) accelerator, a neural computing core, a neural computing engine, a neural processing unit, a purpose-built chip architecture for deep learning, and/or some other machine-learning specific processor that implements a machine learning approach or one or more neural networks using semiconductor (e.g., silicon (Si), gallium arsenide (GaAs)) devices. These processors may also be employed in heterogeneous computing architectures with a number of and/or a variety of different types of cores, engines, nodes, and/or layers to achieve various energy efficiencies, processing speed improvements, data communication speed improvements, and/or data efficiency targets and improvements throughout various parts of the system when compared to a homogeneous computing architecture that employs CPUs for general purpose computing.

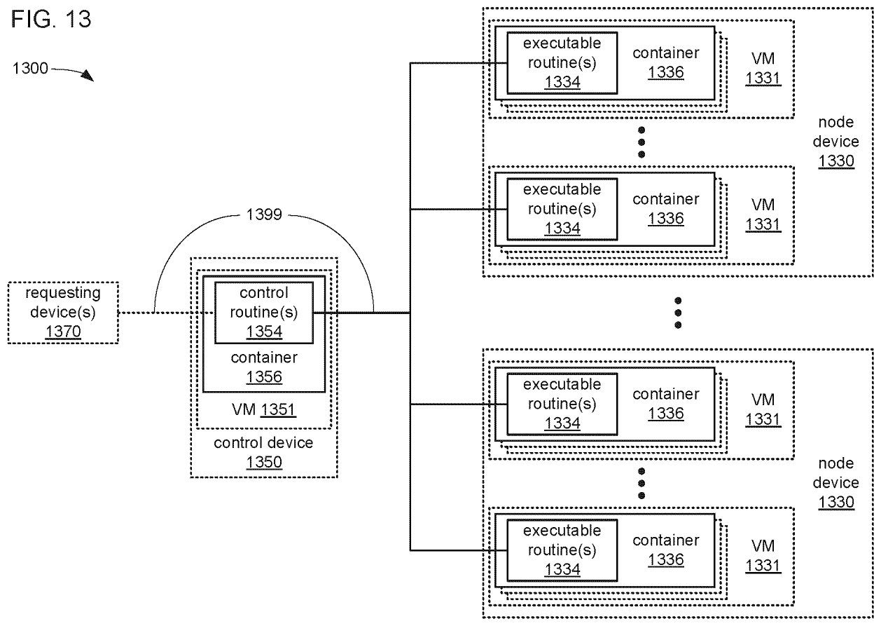

FIG. 13 illustrates various aspects of the use of containers 1336 as a mechanism to allocate processing, storage and/or other resources of a processing system 1300 to the performance of various analyses. More specifically, in a processing system 1300 that includes one or more node devices 1330 (e.g., the aforedescribed grid system 400), the processing, storage and/or other resources of each node device 1330 may be allocated through the instantiation and/or maintenance of multiple containers 1336 within the node devices 1330 to support the performance(s) of one or more analyses. As each container 1336 is instantiated, predetermined amounts of processing, storage and/or other resources may be allocated thereto as part of creating an execution environment therein in which one or more executable routines 1334 may be executed to cause the performance of part or all of each analysis that is requested to be performed.

It may be that at least a subset of the containers 1336 are each allocated a similar combination and amounts of resources so that each is of a similar configuration with a similar range of capabilities, and therefore, are interchangeable. This may be done in embodiments in which it is desired to have at least such a subset of the containers 1336 already instantiated prior to the receipt of requests to perform analyses, and thus, prior to the specific resource requirements of each of those analyses being known.

Alternatively, or additionally, it may be that at least a subset of the containers 1336 are not instantiated until after the processing system 1300 receives requests to perform analyses where each request may include indications of the resources required for one of those analyses. Such information concerning resource requirements may then be used to guide the selection of resources and/or the amount of each resource allocated to each such container 1336. As a result, it may be that one or more of the containers 1336 are caused to have somewhat specialized configurations such that there may be differing types of containers to support the performance of different analyses and/or different portions of analyses.

It may be that the entirety of the logic of a requested analysis is implemented within a single executable routine 1334. In such embodiments, it may be that the entirety of that analysis is performed within a single container 1336 as that single executable routine 1334 is executed therein. However, it may be that such a single executable routine 1334, when executed, is at least intended to cause the instantiation of multiple instances of itself that are intended to be executed at least partially in parallel. This may result in the execution of multiple instances of such an executable routine 1334 within a single container 1336 and/or across multiple containers 1336.

Alternatively, or additionally, it may be that the logic of a requested analysis is implemented with multiple differing executable routines 1334. In such embodiments, it may be that at least a subset of such differing executable routines 1334 are executed within a single container 1336. However, it may be that the execution of at least a subset of such differing executable routines 1334 is distributed across multiple containers 1336.

Where an executable routine 1334 of an analysis is under development, and/or is under scrutiny to confirm its functionality, it may be that the container 1336 within which that executable routine 1334 is to be executed is additionally configured assist in limiting and/or monitoring aspects of the functionality of that executable routine 1334. More specifically, the execution environment provided by such a container 1336 may be configured to enforce limitations on accesses that are allowed to be made to memory and/or I/O addresses to control what storage locations and/or I/O devices may be accessible to that executable routine 1334. Such limitations may be derived based on comments within the programming code of the executable routine 1334 and/or other information that describes what functionality the executable routine 1334 is expected to have, including what memory and/or I/O accesses are expected to be made when the executable routine 1334 is executed. Then, when the executable routine 1334 is executed within such a container 1336, the accesses that are attempted to be made by the executable routine 1334 may be monitored to identify any behavior that deviates from what is expected.

Where the possibility exists that different executable routines 1334 may be written in different programming languages, it may be that different subsets of containers 1336 are configured to support different programming languages. In such embodiments, it may be that each executable routine 1334 is analyzed to identify what programming language it is written in, and then what container 1336 is assigned to support the execution of that executable routine 1334 may be at least partially based on the identified programming language. Where the possibility exists that a single requested analysis may be based on the execution of multiple executable routines 1334 that may each be written in a different programming language, it may be that at least a subset of the containers 1336 are configured to support the performance of various data structure and/or data format conversion operations to enable a data object output by one executable routine 1334 written in one programming language to be accepted as an input to another executable routine 1334 written in another programming language.

As depicted, at least a subset of the containers 1336 may be instantiated within one or more VMs 1331 that may be instantiated within one or more node devices 1330. Thus, in some embodiments, it may be that the processing, storage and/or other resources of at least one node device 1330 may be partially allocated through the instantiation of one or more VMs 1331, and then in turn, may be further allocated within at least one VM 1331 through the instantiation of one or more containers 1336.

In some embodiments, it may be that such a nested allocation of resources may be carried out to affect an allocation of resources based on two differing criteria. By way of example, it may be that the instantiation of VMs 1331 is used to allocate the resources of a node device 1330 to multiple users or groups of users in accordance with any of a variety of service agreements by which amounts of processing, storage and/or other resources are paid for each such user or group of users. Then, within each VM 1331 or set of VMs 1331 that is allocated to a particular user or group of users, containers 1336 may be allocated to distribute the resources allocated to each VM 1331 among various analyses that are requested to be performed by that particular user or group of users.

As depicted, where the processing system 1300 includes more than one node device 1330, the processing system 1300 may also include at least one control device 1350 within which one or more control routines 1354 may be executed to control various aspects of the use of the node device(s) 1330 to perform requested analyses. By way of example, it may be that at least one control routine 1354 implements logic to control the allocation of the processing, storage and/or other resources of each node device 1300 to each VM 1331 and/or container 1336 that is instantiated therein. Thus, it may be the control device(s) 1350 that effects a nested allocation of resources, such as the aforedescribed example allocation of resources based on two differing criteria.

As also depicted, the processing system 1300 may also include one or more distinct requesting devices 1370 from which requests to perform analyses may be received by the control device(s) 1350. Thus, and by way of example, it may be that at least one control routine 1354 implements logic to monitor for the receipt of requests from authorized users and/or groups of users for various analyses to be performed using the processing, storage and/or other resources of the node device(s) 1330 of the processing system 1300. The control device(s) 1350 may receive indications of the availability of resources, the status of the performances of analyses that are already underway, and/or still other status information from the node device(s) 1330 in response to polling, at a recurring interval of time, and/or in response to the occurrence of various preselected events. More specifically, the control device(s) 1350 may receive indications of status for each container 1336, each VM 1331 and/or each node device 1330. At least one control routine 1354 may implement logic that may use such information to select container(s) 1336, VM(s) 1331 and/or node device(s) 1330 that are to be used in the execution of the executable routine(s) 1334 associated with each requested analysis.

As further depicted, in some embodiments, the one or more control routines 1354 may be executed within one or more containers 1356 and/or within one or more VMs 1351 that may be instantiated within the one or more control devices 1350. It may be that multiple instances of one or more varieties of control routine 1354 may be executed within separate containers 1356, within separate VMs 1351 and/or within separate control devices 1350 to better enable parallelized control over parallel performances of requested analyses, to provide improved redundancy against failures for such control functions, and/or to separate differing ones of the control routines 1354 that perform different functions. By way of example, it may be that multiple instances of a first variety of control routine 1354 that communicate with the requesting device(s) 1370 are executed in a first set of containers 1356 instantiated within a first VM 1351, while multiple instances of a second variety of control routine 1354 that control the allocation of resources of the node device(s) 1330 are executed in a second set of containers 1356 instantiated within a second VM 1351. It may be that the control of the allocation of resources for performing requested analyses may include deriving an order of performance of portions of each requested analysis based on such factors as data dependencies thereamong, as well as allocating the use of containers 1336 in a manner that effectuates such a derived order of performance.

Where multiple instances of control routine 1354 are used to control the allocation of resources for performing requested analyses, such as the assignment of individual ones of the containers 1336 to be used in executing executable routines 1334 of each of multiple requested analyses, it may be that each requested analysis is assigned to be controlled by just one of the instances of control routine 1354. This may be done as part of treating each requested analysis as one or more “ACID transactions” that each have the four properties of atomicity, consistency, isolation and durability such that a single instance of control routine 1354 is given full control over the entirety of each such transaction to better ensure that either all of each such transaction is either entirely performed or is entirely not performed. As will be familiar to those skilled in the art, allowing partial performances to occur may cause cache incoherencies and/or data corruption issues.

As additionally depicted, the control device(s) 1350 may communicate with the requesting device(s) 1370 and with the node device(s) 1330 through portions of a network 1399 extending thereamong. Again, such a network as the depicted network 1399 may be based on any of a variety of wired and/or wireless technologies and may employ any of a variety of protocols by which commands, status, data and/or still other varieties of information may be exchanged. It may be that one or more instances of a control routine 1354 cause the instantiation and maintenance of a web portal or other variety of portal that is based on any of a variety of communication protocols, etc. (e.g., a restful API). Through such a portal, requests for the performance of various analyses may be received from requesting device(s) 1370, and/or the results of such requested analyses may be provided thereto. Alternatively, or additionally, it may be that one or more instances of a control routine 1354 cause the instantiation of and maintenance of a message passing interface and/or message queues. Through such an interface and/or queues, individual containers 1336 may each be assigned to execute at least one executable routine 1334 associated with a requested analysis to cause the performance of at least a portion of that analysis.

Although not specifically depicted, it may be that at least one control routine 1354 may include logic to implement a form of management of the containers 1336 based on the Kubernetes container management platform promulgated by Could Native Computing Foundation of San Francisco, CA, USA. In such embodiments, containers 1336 in which executable routines 1334 of requested analyses may be instantiated within “pods” (not specifically shown) in which other containers may also be instantiated for the execution of other supporting routines. Such supporting routines may cooperate with control routine(s) 1354 to implement a communications protocol with the control device(s) 1350 via the network 1399 (e.g., a message passing interface, one or more message queues, etc.). Alternatively, or additionally, such supporting routines may serve to provide access to one or more storage repositories (not specifically shown) in which at least data objects may be stored for use in performing the requested analyses.

### Associated Processes

Retrieval-Augmented Generation (RAG) may refer to a technique in which additional content that is contextually relevant to a user input is retrieved and provided to a large language model (LLM) in order to enable the LLM to generate a more contextually relevant response. RAG may involve segmenting textual data into a set of passages and encoding each of the passages as a vector embedding. The resulting vector embeddings may be indexed and stored in a vector database. When an input for the LLM is received, the input may be transformed into an embedding and compared against embeddings stored within the vector database in order to identify and retrieve the most relevant vector embeddings (e.g., the vector embeddings with a closest proximity relative to the input). The corresponding text from the most relevant vector embeddings may be provided to the LLM as context along with the user input.

As a quantity of vector embeddings stored within the vector database increases, a greater quantity of memory used for storing the number of vector embeddings may likewise increase. Storing and querying these vector embeddings at full precision and full dimensionality may have a higher memory overhead as compared to storing and querying vector embeddings with reduced precision and/or dimensionality. Systems that use vector embeddings at full precision and/or dimensionality may use an increased number of compute resources for processing the vector embeddings as compared to systems that use vector embeddings at reduced precision (e.g., due to quantizing the vector embeddings) and/or dimensionality (e.g., due to applying a dimensionality reduction algorithm to the vector embeddings), thus increasing a likelihood of memory bottlenecks, compute bottlenecks, or overutilization of available compute resources. However, reducing the precision and dimensionality of the vector embeddings (e.g., to save space at the vector database or otherwise reduce a memory footprint) may reduce the effectiveness of a similarity search performed on the vector database (e.g., the most relevant vector embeddings to a user input may be less likely to be retrieved). Techniques that enable vector embeddings to be stored with reduced precision and/or dimensionality while retaining similarity search effectiveness may thus be desired in order to reduce memory overhead.

One technique for reducing memory overhead associated with storing vector embeddings may include fine-tuning embedding models to output lower-dimensional vector embeddings. However, the process of performing training on such embedding models may be computationally expensive. For instance, the training may involve processing large datasets as well as tuning of hyperparameters and may degrade in performance when applied to new corpora (e.g., new datasets), resulting in additional rounds of adaptation. Other techniques, such as token-level filtering or text summarization, may enable compression of data retrieved from the database before being processed by the LLM, but may fail to reduce the memory footprint of the vector database itself.

The techniques described herein utilize an automated vector embedding compression system in order to determine an optimal compression level (e.g., an optimal dimensionality) and an optimal dimension reduction algorithm for a set of vector embeddings. Once the optimal compression level and optimal dimension reduction algorithm are determined, the automated vector embedding compression system may apply the indicated dimension reduction algorithm to the set of vector embeddings to reduce the vector embeddings to the indicated compression level and may store the compressed vector embeddings in the vector database. The vector embedding compression system being automated may refer to the vector embedding compression system automatically generating and comparing vector embeddings at various compression levels and using various dimension reduction algorithms upon receiving the set of vector embeddings in order to determine the optimal compression level and optimal dimension reduction algorithm without additional manual input. The techniques utilized are performed without fine-tuning, thus reducing computational overhead associated with the fine-tuning process. Further, the techniques are performed prior to storing the vector embeddings, enabling a reduction of the memory footprint for the vector database. In some examples, use of quantized or otherwise compressed vector embeddings may result in a vector embedding database that consumes significantly less memory, such as approximately 1 GB, 2 GB, 10 GB, 20 GB, 50 GB, 100 GB, 200 GB, 1 TB, 10 TB, or 30 TB less memory compared to an uncompressed database.

To identify the optimal compression level and the optimal dimensionality reduction algorithm, the automated vector embedding compression system may project an initial set of vector embeddings into multiple lower-dimensional vector embedding sets using one or more dimensionality reduction techniques, such as Principal Component Analysis (PCA) or Discrete Cosine Transform (DCT). Each of the resulting vector embedding sets may have a dimensionality that is less than the dimensionality of the initial set of vector embeddings. The automated vector embedding compression system may further perform quantization on at least a subset of these lower-dimensional vector embedding sets to generate quantized versions of the lower-dimensional vector embedding sets.

Following the quantization process, the automated vector embedding compression system may conduct a k-nearest neighbors (KNN) search or the like on each vector embedding within the quantized sets. The resulting nearest neighbor set for each quantized vector embedding may then be compared to the corresponding nearest neighbor set of the uncompressed vector embedding from the initial set. Any variation between the nearest neighbor sets may be computed as a neighbor preservation metric, which reflects how well the compressed version retains the neighborhood structure of the original embeddings. Each neighbor preservation metric may be evaluated against a predefined target error tolerance. The automated vector embedding compression system may select, from among the quantized sets, the quantized vector embedding set having the lowest dimensionality that still meets the target error tolerance. Additionally, or alternatively, the automated vector embedding compression system may select, among both the quantized and lower-dimensional sets, the vector embedding set associated with the smallest memory footprint that still meets the target error tolerance. The corresponding dimensionality reduction technique may be identified as the optimal algorithm, and the associated dimensionality may be designated as the optimal compression level. The automated vector embedding compression system may then output the compressed vector embeddings, which may be stored in a vector database for subsequent search and retrieval operations.

In contrast to embedding pipelines that store full-precision and full-dimensionality vector embeddings within a vector database, the techniques described herein enable compression of vector embeddings for storage within a vector database while limiting information loss associated with the compression. Accordingly, the vector database may have a reduced memory footprint as compared to vector databases that store full-precision and full-dimensionality vector embeddings and may have reduced information loss as compared to other techniques for compression of vector embeddings prior to storage within a vector database. Further, the techniques described herein may be applied when passages (e.g., context strings) to be embedded are composed of an arbitrarily short number of tokens (e.g., as compared to compression in which generation of separate context summaries from a compression model occurs). The lack of dependency of the automated compression system on a fine-tuned model may enable the automated compression system to be deployed in any sentence embedding model (e.g., in contrast to requiring a model fine-tuning and validation phase before deploying a RAG architecture).

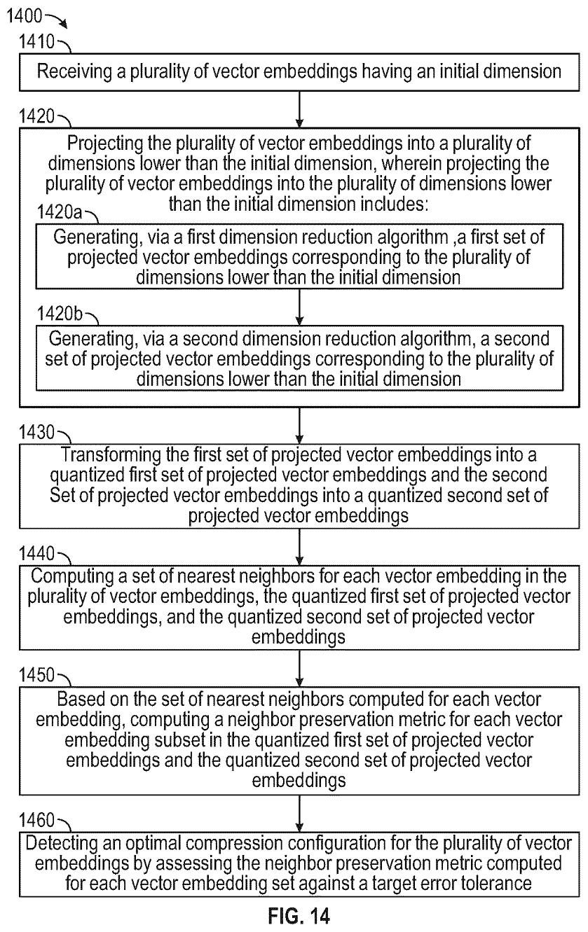

FIG. 14 illustrates one embodiment of method 1400. It shall be appreciated that other embodiments contemplated within the scope of the present disclosure may involve more processes, fewer processes, different processes, or a different order of processes than illustrated in FIG. 14. It should be noted that a computer-program product may include a non-transitory machine-readable storage medium storing computer instructions that, when executed by one or more operations, may perform operations corresponding to the processes and sub-processes of method 1400. Additionally, or alternatively, a computer-implemented method may include operations corresponding to processes and sub-processes of 1400. Additionally, or alternatively, a computer-implemented system may include one or more processors, a memory, and a computer-readable medium operably coupled to the one or more processors, the computer-readable medium having computer-readable instructions stored thereon that, when executed by the one or more processors, cause a computing device to perform operations corresponding to the processes and sub-processes of method 1400.

As shown in FIG. 14, process 1410 of method 1400 may receive a plurality of vector embeddings having an initial dimension. The term “vector embedding” may refer to a numerical representation of a data item-such as a document, sentence, image, or audio segment-encoded as a multi-dimensional vector within a multi-dimensional space (e.g., a vector with at least two entries or components). The term “dimension” may refer to a number of elements or coordinates that each vector embedding has (e.g., 384 bits). In some examples, a respective vector embedding of the plurality of vector embeddings corresponds to a numerical representation of a document in a target embedding space and the initial dimension may correspond to a number of numerical features included in the numerical representation. In a non-limiting example, as described with reference to FIGS. 15A-1 and 15A-2, vector embedding set 1506 may be received with an initial dimension 1508, where vector embedding set 1506 may include vector embeddings 1506A, 1506B, 1506C, and 1506N.

Generally, FIGS. 15A-1 and 15A-2 may depict a procedure for selecting an optimal compression configuration for a set of vector embeddings. For instance, FIGS. 15A-1 and 15A-2 may depict an automated vector embedding compression system creating a set of uncompressed vector embeddings (e.g., vector embeddings 1506) at an initial dimension (e.g., 384 components, dimension 1508) from received user documents using an embedding model 1504. FIGS. 15A-1 and 15A-2 may further depict generating various candidate sets of vector embeddings (e.g., vector embedding sets 1514C, 1514B, 1514A, 1516C, 1516B, and 1516A) using particular dimension reduction algorithms (e.g., PCA 1512A or DCT 1512B) and particular resulting reduced dimensions (e.g., 354 components, 324 components, or 294 components). Additionally, FIGS. 15A-1 and 15A-2 may depict generating additional candidate sets of vector embeddings (e.g., vector embedding sets 1518C, 1518B, 1518A, 1520C, 1520B, and 1520A) by quantizing (e.g., reducing a precision) each of the various candidate sets of vector embeddings. FIGS. 15A-1 and 15A-2 may also depict performing a k-nearest neighbors search on the uncompressed vector embeddings and each of the candidate sets of vector embeddings to determine how similar the k-nearest neighbors of each of the various candidate sets is as compared to the k-nearest neighbors for the uncompressed vector embeddings. The vector embeddings whose k-nearest neighbors are similar enough to the k-nearest neighbors of the uncompressed vector embeddings while having the smallest memory footprint may be selected by the automated vector embedding compression system for storage in a vector database.

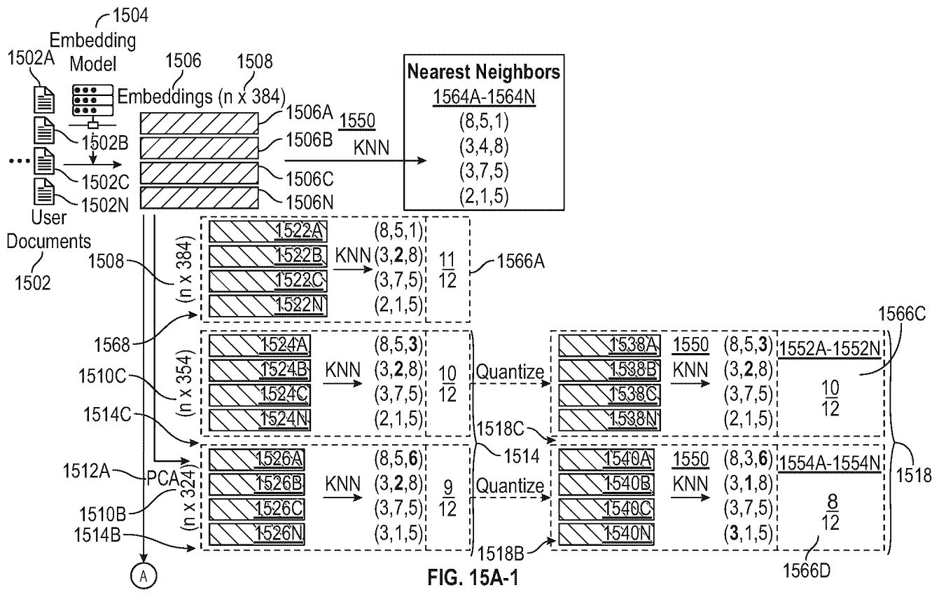

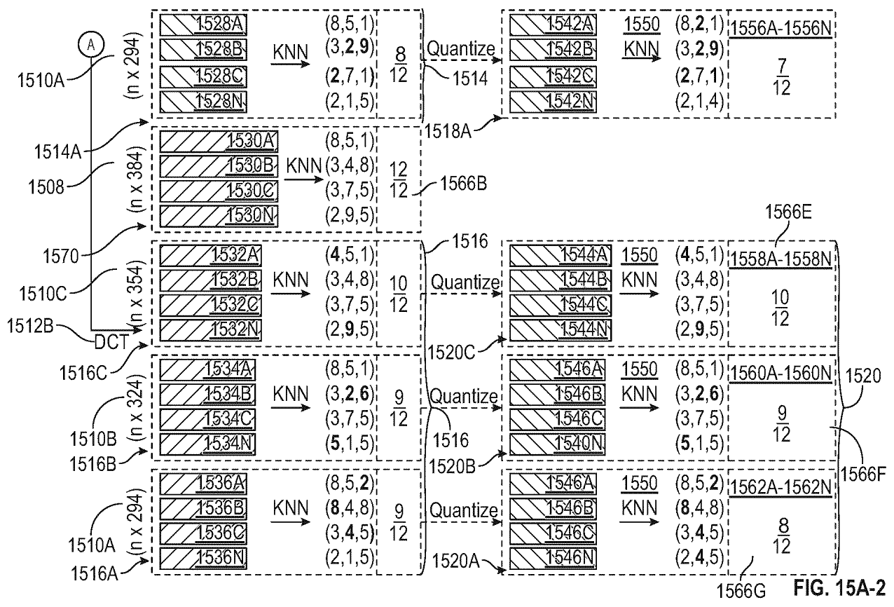

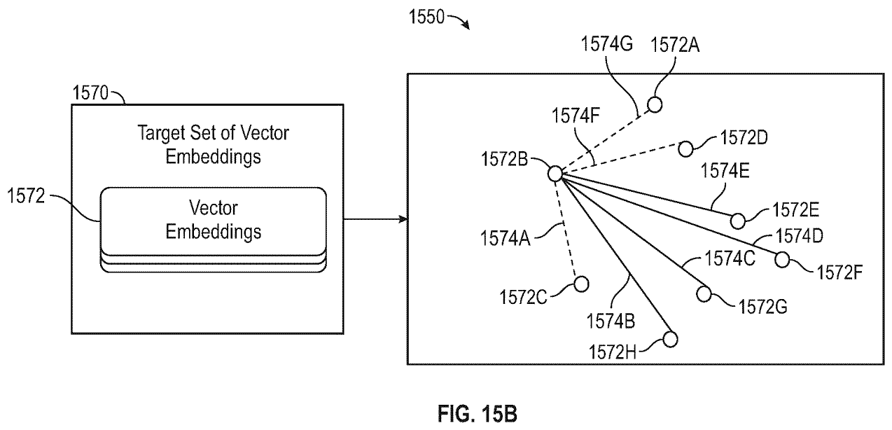

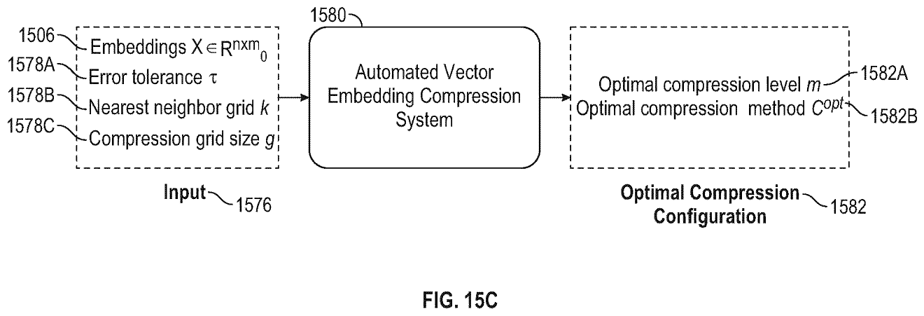

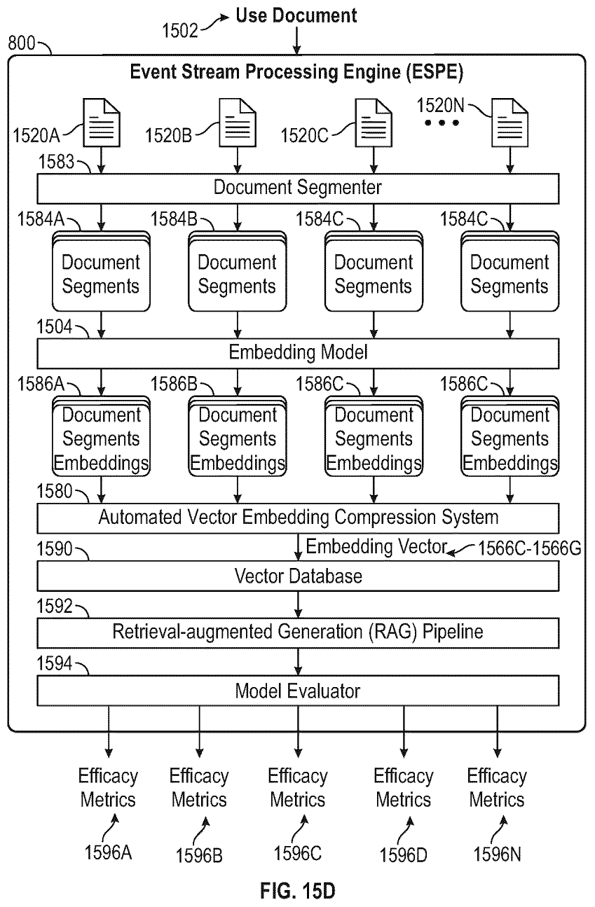

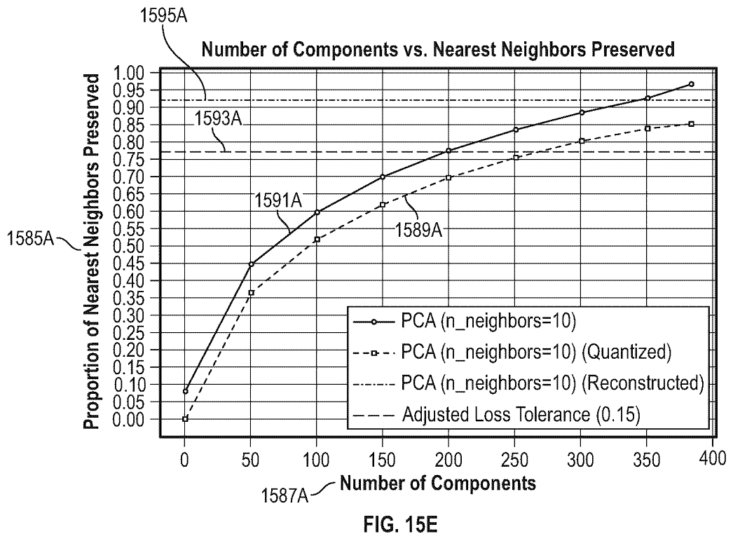

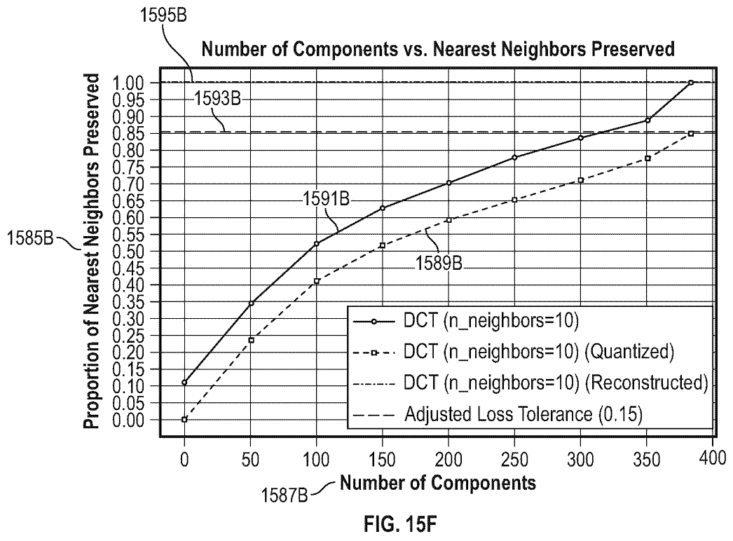

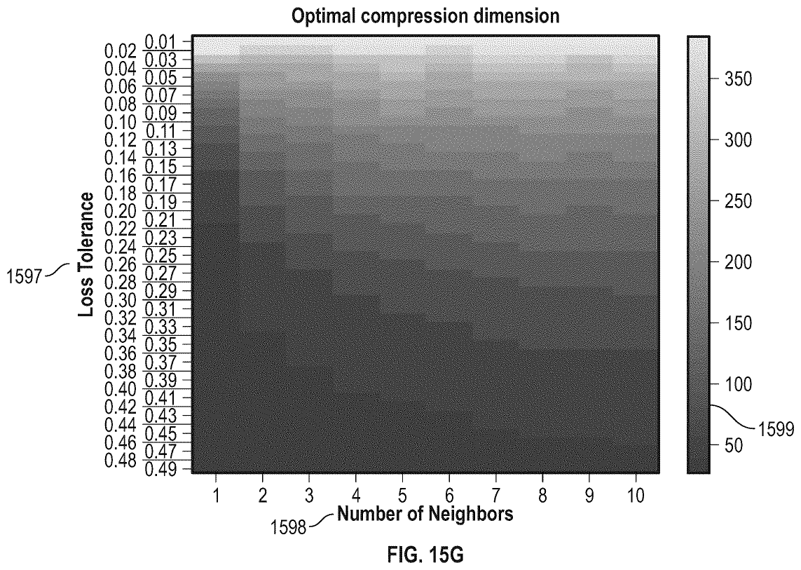

In some examples, the plurality of vector embeddings may be received at an automated compression component of an event stream processing engine (ESPE). An ESPE, as described herein, may refer to a service that processes data in real-time, where the data is received via an event stream. An automated compression component may be one of the modules of the ESPE responsible for compressing vector embeddings. ESPE 800 of FIG. 15D may be an example of an ESPE and automated vector embedding compression system 1580 of FIGS. 18C and 18D may be an example of an automated compression component as described herein.

In order to generate the plurality of vector embeddings, the ESPE may receive (e.g., from a client device), one or more documents; may partition the one or more documents into a set of document segments; may compute the plurality of vector embeddings corresponding to the set of document segments (e.g., one vector embedding for each document segment); and may provide, to the automated compression component of the ESPE, the plurality of vector embeddings having the initial dimension. The term “document” may refer to a file or data object that includes video data, image data, audio data, and/or text data encoded with semantic meaning. In some examples, a document may have at least two distinct modalities where each of video data, image data, audio data, and text data may represent a distinct modality. Thus, the document having multiple modalities may refer to the document having two or more of video data, image data, audio data, and text data.

In some examples, receiving the one or more documents may include the ESPE receiving the one or more documents as a stream over a period of time. For instance, the ESPE may receive the one or more documents from one or more sources that emit discrete events to the ESPE, where each event includes packets of data corresponding to the one or more documents. Alternatively, the ESPE may receive the one or more documents statically (e.g., the documents may be preconfigured at a memory accessible to the ESPE). In a non-limiting example, as described with reference to FIG. 15D, ESPE 800 may receive documents 1502A, 1502B, 1502C, and 1502N.

The term “document segment” may refer to a smaller chunk or subdivision of a larger document created by dividing the larger document. A document may be partitioned into document segments according to one or more rules (e.g., a rule specifying segments should be created according to line breaks, page breaks, ends of sentences, or a predefined number of characters per segment). In a non-limiting example, as described with reference to FIG. 15D, ESPE 800 may provide documents 1502A, 1502B, 1502C, and 1502D to document segmenter 1583 and document segmenter 1583 may partition documents 1502A, 1502B, 1502C, and 1502N into document segments 1584A, 1584B, 1584C, and 1584N, respectively.

Computing the plurality of vector embeddings from the set of document segments may include processing each document segment using an embedding model to generate a corresponding document segment embedding. An embedding model may refer to a machine learning model that transforms input data (e.g., document segments) into vector embeddings. In a non-limiting example, as described with reference to FIG. 15D, ESPE 800 may generate document segment embeddings 1586A, 1586B, 1586C, and 1586N from document segments 1584A, 1584B, 1584C, and 1584N, respectively, via embedding model 1504. In some examples, document segments 1584A, 1584B, 1584C, and 1584N may be the same as or similar to the embeddings computed for documents 1502A through 1502N as described with reference to FIGS. 15A-1 and 15A-2.

After computing the plurality of vector embeddings, the ESPE may provide the plurality of vector embeddings to the automated compression component. For instance, as depicted in FIG. 15D, ESPE 800 may provide document segment embeddings 1586A, 1586B, 1586C, and 1586N to automated vector embedding compression system 1580. Document segment embeddings 1586A, 1586B, 1586C, and 1586N may be collected by the automated vector embedding compression system 1580 to form the vector embedding set 1506 as depicted in FIGS. 15A-1 and 15A-2.

As shown in FIG. 14, process 1420 of method 1400 may project the plurality of vector embeddings into a plurality of dimensions lower than (and/or equal to) the initial dimension. For instance, process 1420 may project a first vector embedding into a first dimension lower than (and/or equal to) the initial dimension and may project the first vector embedding into a second dimension lower than (and/or equal to) the initial dimension and distinct from the first dimension. Projecting a vector embedding into a lower dimension may refer to applying a dimension reduction algorithm (e.g., Principal Component Analysis (PCA), Discrete Cosine Transform (DCT)) onto the vector embedding in order to generate a projected vector embedding (e.g., a dimension-reduced vector embedding).

In some examples, multiple dimension reduction algorithms may be applied to generate multiple respective sets of projected vector embeddings. For instance, sub-process 1420A of process 1420 may generate, via a first dimension reduction algorithm (e.g., PCA), a first set of projected vector embeddings corresponding to the plurality of dimensions lower than (and/or equal to) the initial dimension. Additionally, sub-process 1420B of process 1420 may generate, via a second dimension reduction algorithm (e.g., DCT), a second set of projected vector embeddings corresponding to the plurality of dimensions lower than (and/or equal to) the initial dimension. It should be noted that a granularity of the plurality of dimensions may be user configurable. For instance, with reference to FIGS. 15A-1 and 15A-2, a granularity of 30 may be configured, resulting in a first dimension of 354, a second dimension of 324, a third dimension of 294, and so on.

In a non-limiting example, as depicted in FIGS. 15A-1 and 15A-2, vector embedding set 1506 may be projected into a plurality of dimensions lower than (and/or equal to) initial dimension 1508. Automated vector embedding compression system 1580 may generate, via PCA 1512A, a first set of projected vector embeddings 1514 corresponding to the plurality of dimensions lower than (and/or equal to) the initial dimension. For instance, automated vector embedding compression system 1580 may generate a first vector embedding set 1568 with initial dimension 1508 (e.g., 384), a second vector embedding set 1514C with first reduced dimension 1510C (e.g., 354), a third vector embedding set 1514B with second reduced dimension 1510B (e.g., 324), and a fourth vector embedding set 1514A with third reduced dimension 1510A (e.g., 294), where each of vector embedding sets 1568, 1514A, 1514B, and 1514C may be included in the first set of projected vector embeddings 1514 as respective vector embedding subsets. First vector embedding set 1568 may include vector embeddings 1522A, 1522B, 1522C, and 1522N; second vector embedding set 1514C may include vector embeddings 1524A, 1524B, 1524C, and 1524N; third vector embedding set 1514B may include vector embeddings 1526A, 1526B, 1526C, and 1526N; and fourth vector embedding set 1514A may include vector embeddings 1528A, 1528B, 1528C, and 1528N. Vector embeddings 1522A, 1524A, 1526A, and 1528A may be generated by applying PCA 1512A onto vector embedding 1506A; vector embeddings 1522B, 1524B, 1526B, and 1528B may be generated by applying PCA 1512A onto vector embedding 1506B; vector embeddings 1522C, 1524C, 1526C, and 1528C may be generated by applying PCA 1512A onto vector embedding 1506C; and vector embeddings 1522N, 1524N, 1526N, and 1528N may be generated by applying PCA 1512A onto vector embedding 1506N.

Similarly, automated vector embedding compression system 1580 may generate, via DCT 1512B, a second set of projected vector embeddings 1516 corresponding to the plurality of dimensions lower than (and/or equal to) the initial dimension. For instance, automated vector embedding compression system 1580 may generate a fifth vector embedding set 1570 with initial dimension 1508 (e.g., 384), a sixth vector embedding set 1516C with first reduced dimension 1510C (e.g., 354), a seventh vector embedding set 1516B with second reduced dimension 1510B (e.g., 324), and a fourth vector embedding set 1516A with third reduced dimension 1510C (e.g., 294), where each of vector embedding sets 1570, 1516A, 1516B, and 1516C may be included in the second set of projected vector embeddings 1516 as respective vector embedding subsets. Fifth vector embedding set 1570 may include vector embeddings 1530A, 1530B, 1530C, and 1530N; sixth vector embedding set 1516C may include vector embeddings 1532A, 1532B, 1532C, and 1532N; seventh vector embedding set 1516B may include vector embeddings 1534A, 1534B, 1534C, and 1534N; and eighth vector embedding set 1516A may include vector embeddings 1536A, 1536B, 1536C, and 1536N. Vector embeddings 1530A, 1532A, 1534A, and 1536A may be generated by applying DCT 1512B onto vector embedding 1506A; Vector embeddings 1530B, 1532B, 1534B, and 1536B may be generated by applying DCT 1512B onto vector embedding 1506B; Vector embeddings 1530C, 1532C, 1534C, and 1536C may be generated by applying DCT 1512B onto vector embedding 1506A; and Vector embeddings 1530N, 1532N, 1534N, and 1536N may be generated by applying DCT 1512B onto vector embedding 1506N.

In some examples, the first set of projected vector embeddings and the second set of projected vector embeddings are concurrently computed by the first dimension reduction algorithm and the second dimension reduction algorithm. Concurrently computing the first set of projected vector embeddings and the second set of projected vector embeddings may refer to executing the first dimension reduction algorithm in parallel with the second dimension reduction algorithm.

As shown in FIG. 14, process 1430 of method 1400 may transform the first set of projected vector embeddings into a quantized first set of projected vector embeddings and the second set of projected vector embeddings into a quantized second set of projected vector embeddings. Transforming a vector embedding into a quantized vector embedding may involve reducing a numerical precision (e.g., a bit precision) of the elements within the vector embedding. For instance, each vector embedding may include a number of components (e.g., 384 components), where each component indicates a number represented by a respective quantity of bits. The quantity of bits used to represent the number indicated by each component may be referred to as its precision. In an example, if the number indicated by a component of a vector embedding is a 32-bit or a 64-bit float, the precision of the vector embedding may be 32 bits or 64 bits, respectively. Likewise, if the number indicated by a component of a vector embedding is an 8-bit signed integer, the precision of the vector embedding may be 8 bits. Reducing the numerical precision of a vector embedding may include reducing the number of bits used to represent the respective number indicated by each component within the vector embedding. For instance, if the components within the vector embedding indicate 32-bit floating-point values, transforming the vector embedding to the quantized vector embedding may involve converting the 32-bit floating-point values to 8-bit integers. In some examples, the transformation may perform uniform quantization, in which a value range of each embedding dimension is divided into equal-sized intervals and each value may be mapped to the nearest representative bin. It should be noted that the term “element” may be used instead of “component” without deviating from the scope of the present disclosure.

In a non-limiting example, as described with reference to FIGS. 15A-1 and 15A-2, automated vector embedding compression system 1580 may transform the first set of projected vector embeddings 1514 into a quantized first set of projected vector embeddings 1518. For instance, automated vector embedding compression system 1580 may transform the second vector embedding set 1514C to quantized second vector embedding set 1518C; third vector embedding set 1514B to quantized third vector embedding set 1518B; and fourth vector embedding set 1514A to quantized fourth vector embedding set 1518A. For second vector embedding set 1514C, vector embeddings 1524A, 1524B, 1524C, and 1524N may be transformed into vector embeddings 1538A, 1538B, 1538C, and 1538N, respectively. For third vector embedding set 1514B, vector embeddings 1526A, 1526B, 1526C, and 1526N may be transformed into vector embeddings 1540A, 1540B, 1540C, and 1540N, respectively. For fourth vector embedding set 1514A, vector embeddings 1528A, 1528B, 1528C, and 1528N may be transformed into vector embeddings 1542A, 1542B, 1542C, and 1542N, respectively.

Similarly, as described with reference to FIGS. 15A-1 and 15A-2, automated vector embedding compression system 1580 may transform second set of projected vector embeddings 1516 into a quantized second set of projected vector embeddings 1520. For instance, automated vector embedding compression system 1580 may transform sixth vector embedding set 1516C to quantized sixth vector embedding set 1520C; seventh vector embedding set 1516B to quantized seventh vector embedding set 1520B; and eighth vector embedding set 1516A to quantized fourth vector embedding set 1520A. For sixth vector embedding set 1516C, vector embeddings 1532A, 1532B, 1532C, and 1532N may be transformed into vector embeddings 1544A, 1544B, 1544C, and 1544N, respectively. For seventh vector embedding set 1516B, vector embeddings 1534A, 1534B, 1534C, and 1534N may be transformed into vector embeddings 1546A, 1546B, 1546C, and 1546N, respectively. For eighth vector embedding set 1516A, vector embeddings 1536A, 1536B, 1536C, and 1536N may be transformed into vector embeddings 1548A, 1548B, 1548C, and 1548N, respectively.

In some examples, the first set of projected vector embeddings and the second set of projected vector embeddings may be concurrently transformed into the quantized first set of projected vector embeddings and the quantized second set of vector embeddings. Concurrently transforming the first set of projected vector embeddings and the second set of projected vector embeddings may refer to executing the transformation for the first set of projected vector embeddings in parallel with that for the second set of projected vector embeddings.

As shown in FIG. 14, process 1440 of method 1400 may compute a set of nearest neighbors for each vector embedding in the plurality of vector embeddings, the quantized first set of projected vector embeddings, and the quantized second set of projected vector embeddings. Computing the set of nearest neighbors for a particular vector embedding may refer to determining the most similar vector embeddings (e.g., the k most similar vector embeddings, where k is an integer greater than or equal to 1) to the particular vector embedding. The vector embeddings most similar to the particular vector embedding may be those that have a smallest distance metric value (e.g., cosine similarity or Euclidean distance) relative to the particular vector embedding. For instance, process 1440 may compute a set of vector distances between the respective vector embedding and additional vector embeddings in a target set of vector embeddings and, based on the set of vector distances, may detect a subset of the additional vector embeddings that have a shortest vector distance to the respective vector embedding relative to a remainder of the additional vector embeddings. Upon detecting the subset of the additional vector embeddings, process 1440 may select the subset of the additional vector embeddings as the set of nearest neighbors for the respective vector embedding.

In a non-limiting example, as described with reference to FIGS. 15A-1 and 15A-2, automated vector embedding compression system 1580 may compute KNN 1550 for vector embeddings set 1506. For instance, automated vector embedding compression system 1580 may determine, when k is equal to 3, three nearest neighbors for vector embedding 1506A (e.g., k nearest neighbors, where k is an integer greater than o). Accordingly, the nearest neighbor set 1564A for vector embedding 1506A may be (8, 5, 1) (e.g., a first vector embedding of vector embeddings 1506 with an assigned index 8, a second vector embedding of vector embedding 1506 with an assigned index 5, and a third vector embedding of vector embeddings 1506 with an assigned index 1). Likewise, automated vector embedding compression system 1580 may determine, when k is equal to 3, that the nearest neighbor set 1564B for vector embedding 1506B is (3, 4, 8), the nearest neighbor set 1524C for vector embedding 1506C is (3, 7, 5), and that the nearest neighbor set 1524N for vector embedding 1506N is (2, 1, 5). Generally, the nearest neighbor set may be described with the form (a₁, a₂, . . . , aₖ), where k is the number of nearest neighbors in the set and aᵢ may be the ith neighbor within the set. Automated vector embedding compression system 1580 may determine, in a similar manner nearest neighbor sets 1552A, 1552B, 1552C, and 1552N for vector embedding set 1518C; nearest neighbor sets 1554A, 1554B, 1554C, and 1554N for vector embedding set 1518B; nearest neighbor sets 1556A, 1556B, 1556C, and 1556N for vector embedding set 1518A; nearest neighbor sets 1558A, 1558B, 1558C, and 1558N for vector embedding set 1520C; nearest neighbor sets 1560A, 1560B, 1560B, and 1560B for vector embedding set 1520B; and nearest neighbor sets 1562A, 1562B, 1562C, and 1562N for vector embedding set 1520A. Additionally, the automated vector embedding compression system 1580 may compute KNN 1550 for each vector embedding of vector embedding sets 1514A, 1514B, 1514C, 1516A, 1516B, 1516C, 1568, and 1570 (e.g., relative to other vector embeddings within the respective set).

A non-limiting example of determining a nearest neighbor set for a vector embedding set may be depicted with reference to FIG. 15B. For instance, target vector embedding set 1570 may include vector embeddings 1572. Vector embeddings 1572 may include vector embeddings 1572A, 1572B, 1572C, 1572D, 1572E, 1572F, 1572G, and 1572H. An automated vector embedding compression system 1580 may determine the k-nearest neighbors for vector embedding 1572B. For instance, automated vector embedding compression system 1580 may determine a path 1574A (e.g., a distance, a displacement) between vector embedding 1572B and vector embedding 1572C; a path 1574B between vector embedding 1572B and vector embedding 1572H; a path 1574C between vector embedding 1572B and vector embedding 1572G; a path 1574D between vector embedding 1572B and vector embedding 1572F; a path 1574E between vector embedding 1572B and vector embedding 1572E; a path 1574F between vector embedding 1572B and vector embedding 1572D; and a path 1574G between vector embedding 1572B and vector embedding 1572A. In examples in which the three nearest neighbors are determined (e.g., k equals 3, vector embedding compression system 1580 may determine that vector embeddings 1572A, 1572D, and 1572C are the three nearest neighbors (e.g., due to paths 1574G, 1574F, and 1574A being the shortest paths).

As shown in FIG. 14, process 1450 of method 1400 may, based on the set of nearest neighbors computed for each vector embedding, compute a neighbor preservation metric for each vector embedding subset in the quantized first set of projected vector embeddings and the quantized second set of projected vector embeddings. The term “neighbor preservation metric” may refer to a metric that indicates, when performing projection and/or quantization on vector embeddings, how many of the nearest neighbors (e.g., the k closest neighbors) for the vector embeddings are the same after modifying the vector embeddings as compared to before the modifying is performed.

Computing the neighbor preservation metric for a quantized or projected vector embedding in a vector embedding subset may include detecting one or more nearest neighbor variants in the vector embedding subset by assessing the set of nearest neighbors computed for each vector embedding in the embedding subset against the set of nearest neighbors computed for each vector embedding in the plurality of vector embeddings. In a non-limiting example, as described with reference to FIGS. 15A-1 and 15A-2, automated vector embedding compression system 1580 may detect one or more nearest neighbor variants in vector embedding set 1514C by assessing the set of nearest neighbor embeddings for each of vector embeddings 1524A, 1524B, 1524C, and 1524N against the set of nearest neighbors computed for each vector embedding in the plurality of vector embeddings (e.g., nearest neighbor sets 1564A through 1564N corresponding to vector embeddings 1506A through 1506N). For instance, automated vector embedding compression system 1580 may detect a nearest neighbor variant for vector embedding 1524A relative to vector embedding 1506A (e.g., the nearest neighbor set for vector embedding 1524A may be (8, 5, 3), whereas the nearest neighbor set 1564A may be (8, 5, 1), thus having a difference of 1). Similarly, automated vector embedding compression system 1580 may detect a nearest neighbor variant for vector embedding 1524B relative to vector embedding 1506B (e.g., the nearest neighbor set for vector embedding 1524B may be (3, 2, 8), whereas the nearest neighbor set 1564B may be (3, 4, 8), thus having a difference of 1. Automated vector embedding compression system 1580 may not detect nearest neighbor variants for vector embeddings 1524C and 1524D, as each of these vector embeddings may have nearest neighbor sets that match nearest neighbors 1564C and 1564N, respectively. Similar detection may occur for vector embedding sets 1514A, 1514B, 1516A, 1516B, 1516C, 1518A, 1518B, 1518C, 1520A, 1520B, 1520C, 1568, and 1570.

Additionally, computing the neighbor preservation metric for the quantized or projected vector embedding in the vector embedding subset may include computing a proportion of nearest neighbors preserved in the respective vector embedding subset based on a count of the one or more nearest neighbor variants relative to a total number of nearest neighbors computed across the plurality of vector embeddings. In a non-limiting example, as described with reference to FIGS. 15A-1 and 15A-2, automated vector embedding compression system 1580 may compute a proportion of nearest neighbors preserved in vector embedding set 1514C based on a count of the one or more nearest neighbor variants (e.g., two nearest neighbor variants) relative to a total number of nearest neighbors computed across the plurality of vector embeddings (e.g., twelve nearest neighbors within nearest neighbor sets 1564A through 1564N). For instance, a neighbor preservation metric of 10/12 may be computed for vector embedding set 1510C because two of the nearest neighbors may differ for vector embedding set 1510C as compared to nearest neighbor sets 1564A through 1564N. Similarly, a neighbor preservation metric 1566A may be computed for vector embedding set 1568, a neighbor preservation metric 1566B may be computed for vector embedding set 1570, a neighbor preservation metric 1566C may be computed for vector embedding set 1518C, a neighbor preservation metric 1566D may be computed for vector embedding set 1518B, a neighbor preservation metric 1566E may be computed for vector embedding set 1520C, a neighbor preservation metric 1566F may be computed for vector embedding set 1520B, and nearest neighbor preservation may be calculated for vector embedding set 1520A.

As shown in FIG. 14, process 1460 of method 1400 may detect an optimal compression configuration for the plurality of vector embeddings by assessing the neighbor preservation metric computed for each vector embedding set against a target error tolerance. The optimal compression configuration may define an optimal compression level (e.g., an optimal dimension for projected and/or quantized vectors) and an optimal dimension reduction algorithm (one of PCA or DCT) for the plurality of vector embeddings. The term “error tolerance” may refer to a metric measuring an amount of information loss associated with projecting a vector embedding into a lower dimension and/or quantizing the vector embedding. A target error tolerance may refer to a threshold for error tolerance that defines an acceptable amount of error tolerance that may occur in projecting and/or quantizing vector embeddings.

A non-limiting example of performing vector embedding compression may be described with reference to FIG. 15C. Automated vector embedding compression system 1580 may receive, as inputs 1576, vector embeddings 1506 (i.e., X∈ [symbol] ^{n×m}^{₀}) error tolerance 1578A (i.e., t), nearest neighbor grid 1578B (i.e., k), and compression grid size 1578C (i.e., g). Vector embeddings 1506 may be a collection of n vector embeddings with dimension m₀ (e.g., initial dimensions 1508). Error tolerance 1578A may be an error tolerance (e.g., specified by a user and/or edge device) that may control an acceptable amount of information loss with projection and/or quantization. Nearest neighbor grid 1578B may be an array of numbers of neighbors to consider during compression optimization. Compression grid size 1578C may be a compression grid interval that controls the resolution of the compression search interval. In some examples, error tolerance 1578A may be a hyperparameter that defines the target error tolerance; nearest neighbor grid 1578B may be a hyperparameter that defines a number of nearest neighbors to include in the set of nearest neighbors computed for each vector embedding; and compression grid size 1578C may be a hyperparameter that defines a compression interval used to determine the plurality of dimensions lower than (and/or equal to) the initial dimension.

Outputs 1582 (e.g., an optimal compression configuration) from automated vector embedding compression system 1580 may include optimal compression level 1582A (i.e., m) and optimal compression method 1582B (i.e., C^{opt}). Automated vector embedding compression system 1580 may compress matrix X to different compression level using DCT or projection using PCA on X (e.g., by process 1420) and, after applying either DCT or PCA, the embeddings may be quantized (e.g., by process 1430) using a uniform quantization approach (i.e., DCTq, PCAq). After compression (e.g., projection) and quantization, k-nearest neighbors may be generated for each of compression and quantization schemes for comparison (e.g., by process 1440).

Formally, a rule for optimal compression may be defined based on the nearest neighbor calculations for each compression level. [symbol] (m₀, k)ᵢ may be the set of k-nearest neighbors of embedding i in the original embedding space (e.g., nearest neighbor sets 1564A through 1564N); [symbol] (PCA(m), k)ᵢ may be the set of k-nearest neighbors of embedding i for embeddings projected on the first m<m₀ principal components of embedding matrix X (e.g., nearest neighbor sets for one or more of vector embedding sets 1568, 1514C, 1514B, and 1514A); [symbol] (DCT (m), k)ᵢ may be the set of k-nearest neighbors of embedding i for embeddings projected on the m<m₀ lowest frequency components of the DCT (e.g., nearest neighbor sets for one or more of vector embedding sets 1570, 1516C, 1516B, and 1516A); [symbol] (PCAq(m), k)ᵢ may be the set of k-nearest neighbors of embedding i for quantized variants of PCA (e.g., nearest neighbor sets for vector embedding sets 1518C, 1518B, and 1518A); and [symbol] (DCTq (m), k)ᵢ may be the set of k-nearest neighbors of embedding i for quantized variants of DCT (e.g., nearest neighbor sets for vector embedding sets 1520C, 1520B, and 1520A). Additionally,

$$( {1}^{} , {2}^{} , k ) = \frac{1}{n k} {\sum }_{i = 1}^{n} {i}_{1}^{} ⋂ {i}_{2}^{}$$

may be the proportion of shared nearest neighbors between [symbol] ¹ and [symbol] ² (e.g., between any of vector embedding sets 1514A, 1514B, 1514C, 1516A, 1516B, 1516C, 1518A, 1518B, 1518C, 1520A, 1520B, 1520C, 1568, 1570, and 1506).

One technique for performing compression may have nearest neighbors in an original space [symbol] (m₀, k) and nearest neighbors in another space [symbol] * such that P( [symbol] (m₀, k), [symbol] *, k)=1 (e.g., there is no difference in nearest neighbors between the two spaces. However, embedding databases may have identical or near identical vector embeddings due to similarities between strings represented in the database. As such, orthonormal rotations of the embedding co-ordinate system may result in changes to how ties between identical embeddings are resolved. In addition, numeric perturbations during transformation using the principal components or DCT may also result in changes in how near-ties between embeddings are resolved during the nearest neighbor identification process. To adapt the optimal proportion of nearest neighbors to account for the differences of the types described herein, an optimal value may be defined as the proportion preserved after projecting on the full subspace using either DCT or PCA. For instance,

$${P}_{P C A}^{opt} ( k ) = {P}_{P C A q}^{opt} ( k ) = P ( ( PCA ( {m}_{0} , k ) , ( {m}_{0} , k ) ) and$$

$${P}_{DCT}^{opt} ( k ) = {P}_{DCTq}^{opt} ( k ) = P ( ( DCT ( {m}_{0} , k ) , ( {m}_{0} , k ) ) .$$

As depicted in FIGS. 15A-1 and 15A-2,

$${P}_{P C A}^{opt} ( 3 ) = \frac{11}{12}$$

(e.g., neighbor preservation metric 1566A may equal 11/12) and

$${P}_{D C T}^{opt} ( 3 ) = \frac{12}{12}$$

(e.g., neighbor preservation metric 1566B may equal 12/12) because 11 of 12 and 12 of 12 nearest neighbors, respectively, may be preserved when projecting onto the full PCA/DCT basis with dimension 384.

After computing the optimal proportion, error tolerance τ (e.g., error tolerance 1578A) may be adjusted by computing the set of nearest neighbors for each vector embedding in the plurality of vector embeddings (e.g., [symbol] (m₀, k)ᵢ); computing a second set of nearest neighbors for each vector embedding in the plurality of vector embeddings (e.g., one of [symbol] (PCA(m₀), k)ᵢ, [symbol] (DCT (m₀), k)ᵢ, [symbol] (PCAq(m₀), k)ᵢ, or [symbol] (DCTq (m₀), k)ᵢ); computing a proportion of nearest neighbors preserved between the set of nearest neighbors and the second set of nearest neighbors computed for each vector embedding in the plurality of vector embeddings

$$( e . g . , {P}_{*}^{opt} ( k ) ,$$

where *∈{PCA, DCT, PCAq, DCTq}); and adjusting the target error tolerance by subtracting the proportion of nearest neighbors preserved between the set of nearest neighbors and the second set of nearest neighbors from the error tolerance τ

$$( e . g . , {\tilde{τ}}_{*} ( k ) = {P}_{*}^{opt} ( k ) - τ ,$$

where *∈{PCA, DCT, PCAq, DCTq}). For instance, in a non-limiting example as described with reference to FIGS. 15A-1 and 15A-2, automated vector embedding compression system 1580 may subtract t from neighbor preservation metric 1566A or neighbor preservation metric 1566B to determine the adjusted value of t.

In order to detect the optimal compression configuration for the plurality of vector embeddings, the automated vector compression system 1580 may detect that the neighbor preservation metric for a plurality of vector embedding subsets in the quantized first set of projected vector embeddings and the quantized second set of projected vector embeddings satisfy the target error tolerance (e.g., the adjusted error tolerance value). For instance, as described with reference to FIGS. 15A-1 and 15A-2, automated vector compression system 1580 may determine that neighbor preservation metrics 1566C, 1566D, 1566E, 1566F, and 1566G satisfy the target error tolerance (e.g., whereas the neighbor preservation metric for vector embedding set 1518A may not satisfy the target error tolerance).

Further, in order to detect the optimal compression configuration, the automated vector compression system 1580 may detect that the neighbor preservation metric computed for a first vector embedding subset is associated with a fewer number of components compared to the neighbor preservation metric associated with a remainder of the plurality of vector embedding subsets. In a non-limiting example, as described with reference to FIGS. 15A-1 and 15A-2, neighbor preservation metrics 1566C and 1566E may be calculated for vector embeddings with an associated dimension of 354, neighbor preservation metrics 1566D and 1566F may be calculated for vector embeddings with an associated dimension of 324; and neighbor preservation metric 1566G may be calculated for vector embeddings with an associated dimension of 294. Thus, neighbor preservation metric 1566G may be associated with the fewest number of components of the remaining neighbor preservation metrics satisfying the target error tolerance.

Additionally, in order to detect the optimal compression configuration, the automated vector compression system 1580 may select a number of components and a dimension reduction algorithm associated with the neighbor preservation metric computed for the first vector embedding subset as the optimal compression configuration for the plurality of vector embeddings

$$( e . g . , {m}^{opt} , {𝒞}^{opt} = {arg min}_{m \times c : m ∈ ℳ , 𝒞 ∈ \{ PCA , PCAq , DCTq \}} ( {\tilde{τ}}_{𝒞} ( k ) - P ( ( ( m , k ) , ( {m}_{0} , k ) ) )$$

subject to [symbol] (k)<P( [symbol] ( [symbol] (m,k), [symbol] (m₀, k))). For instance, in a non-limiting example, as described with reference to FIGS. 15A-1 and 15A-2, as neighbor preservation metric 1566G may be associated with the fewest components, a number of components of 294 and a dimension reduction algorithm of DCTq may be selected.

In some examples, after detecting the optimal compression configuration, the automated vector embedding compression system may output, to a graphical user interface, a visual or textual indication of the detected optimal compression configuration. The visual or textual indication may include a selected dimension reduction algorithm (e.g., PCA, DCT, PCAq, DCTq) and a selected compression level. The indication may further include one or more metrics such as a proportion of nearest neighbors preserved (e.g., a neighbor preservation metric). In some examples, the output may include the results of multiple compression configurations and/or may include graphs or plots illustrating the performance of various compression configurations.

In some examples, the set of nearest neighbors may be computed for each vector embedding in the first set of projected vector embeddings and the second set of projected vector embeddings and the neighbor preservation metric is further computed for each vector embedding subset in the first set of projected vector embeddings and the second set of projected vector embeddings. In such examples, detecting the optimal compression configuration for the plurality of vector embeddings includes: detecting that the neighbor preservation metric computed for each vector embedding subset in the quantized first set of projected vector embeddings and the quantized second set of projected vector embeddings does not satisfy the target error tolerance and detecting that the neighbor preservation metric computed for a first vector embedding subset in the first set of projected vector embeddings satisfies the target error tolerance. Additionally, detecting the optimal compression configuration includes selecting a number of components and a dimension reduction algorithm associated with the neighbor preservation metric computed for the first vector embedding subset as the optimal compression configuration for the plurality of vector embeddings. In a non-limiting example, as described with reference to FIGS. 15A-1 and 15A-2, if the adjusted target error threshold is larger than neighbor preservation metric 1566G but smaller than the neighbor preservation metric for vector embedding set 1516A, then a compression level of 294 and a dimension reduction algorithm of DCT (e.g., non-quantized) may be selected.

In some examples, the automated vector embedding compression system may generate a compression efficacy artifact for the plurality of vector embeddings. The compression efficacy graph may include one or more of a first graph depicting a relationship between a number of components and proportion of nearest neighbors preserved for the first dimension reduction algorithm (e.g., FIG. 15E); a second graph depicting a relationship between the number of components and the proportion of nearest neighbors preserved for the second dimension reduction algorithm (e.g., FIG. 15F); and a third graph depicting a plurality of compression configuration outcomes as a function of loss tolerance and number of neighbors (e.g., FIG. 15G). Each of these compression efficacy artifacts may be provided to a user interface (e.g., a graphical user interface) or included in a report.

FIG. 15E may illustrate a graph depicting a relationship between a number of components 1587A (e.g., a dimensionality of a vector embedding) and a proportion 1585A of nearest neighbors preserved when PCA is performed (e.g., a value of the corresponding neighbor preservation metric). Curve 1589A may depict values of the proportion 1585A for a plurality of vector embeddings when reduced to a particular component number (e.g., 384, 350, 300, 250, 200, 150, 100, 50, and 0) according to PCA and then quantized. Curve 1591A may depict values of the proportion 1585A for a plurality of vector embeddings when reduced to the particular component number according to PCA (e.g., without being quantized). Threshold 1593A may represent a value of an adjusted loss tolerance (e.g., an error tolerance) and threshold 1595A may represent a value of the proportion 1585A after performing PCA on the plurality of vector embeddings without reducing dimensionality. The difference between threshold 1595A and threshold 1593A may be the initially configured loss tolerance (e.g., initially configured error tolerance). When points on curves 1591A and 1589A are above threshold 1593A, they may satisfy the adjusted loss tolerance. However, when points on curves 1591A and 1589A are below threshold 1593A, they may not satisfy the adjusted loss tolerance.

In a non-limiting example, as illustrated with reference to FIG. 15E, loss tolerance may be set to 0.15. The proportion of nearest neighbors when projecting the plurality of vector embeddings onto a full set of principal components may yield a proportion of nearest neighbors preserved of

$${P}_{D C T}^{opt} ( 10 ) = 0.919 .$$

Given this value and a loss tolerance of =0.15, the adjusted loss tolerance threshold may be \tilde{τ}_{PCA}(10)=0.919−0.15=0.769. The lowest number of components exceeding this threshold for each compression method (e.g., PCA and PCAq) may correspond to the optimal level of compression for this method. For instance, for PCA, embeddings compressed to length 200 may have a proportion of nearest neighbors equal to 0.773, which may exceed the adjusted tolerance threshold value of 0.769. Likewise, for PCAq, the embeddings compressed by PCA to length 300 followed by quantization may have a proportion of nearest neighbors equal to 0.787 which may exceed the adjusted tolerance threshold value of 0.769. After finding the optimal level of compression for each method, a determination on the most efficient method may be made. Because 8 bit quantization yields a memory footprint ¼^{th} that of the original 32 bit float values, the following memory cost of PCAq to dimension 300 versus PCA to dimension 200 may be equal to (300/4)/200=0.375. Thus, PCAq at compression level 300 may have approximately ⅓ the memory footprint of PCA at compression level 200 while still exceeding the adjusted loss tolerance threshold. Accordingly, PCAq to compression level 300 may be the optimal compression strategy.

FIG. 15F may illustrate a graph depicting a relationship between a number of components 1587B (e.g., a dimensionality of a vector embedding) and a proportion 1585B of nearest neighbors preserved when DCT is performed (e.g., a value of the corresponding neighbor preservation metric). Curve 1589B may depict values of the proportion 1585B for a plurality of vector embeddings when reduced to a particular component number (e.g., 384, 350, 300, 250, 200, 150, 100, 50, and 0) according to DCT and then quantized. Curve 1591B may depict values of the proportion 1585B for a plurality of vector embeddings when reduced to the particular component number according to DCT (e.g., without being quantized). Threshold 1593B may represent a value of an adjusted loss tolerance (e.g., an error tolerance) and threshold 1595B may represent a value of the proportion 1585B after performing DCT on the plurality of vector embeddings without reducing dimensionality. The difference between threshold 1595B and threshold 1593B may be the initially configured loss tolerance (e.g., initially configured error tolerance). When points on curves 1589B and 1591B are above threshold 1593B, they may satisfy the adjusted loss tolerance. However, when points on curves 1589B and 1591B are below threshold 1593B, they may not satisfy the adjusted loss tolerance.

In a non-limiting example, FIG. 15F may show P( [symbol] (PCA(m,k), [symbol] (m,k)) and P( [symbol] (PCAq(m,k), [symbol] (m,k)) as a function of m and may include horizontal lines (e.g., thresholds) for reconstructed nearest neighbors,

$${P}_{P C A}^{opt} ( 10 ) ,$$

and the adjusted loss tolerance \tilde{τ}_{PCA}(10). Loss tolerance may be set to 0.15. The DCT nearest neighbor preservation information may yield a proportion of nearest neighbors preserved of

$${P}_{P C A}^{opt} ( 10 ) \approx 1$$

as reconstructed DCT embeddings may have a recovery rate at greater than 0.999 (e.g., due to DCT preserving the ordering of embeddings, thus being less sensitive to re-ordering of near ties among neighbors). Thus, the adjusted loss tolerance for DCT may be 0.999-0.15=0.849. The smallest DCT compression attaining a proportion of nearest neighbors preserved exceeding the adjusted loss tolerance value of 0.849 may be at compression size 850. Quantized DCT (i.e., DCTq) compression may not achieve a nearest neighbor preservation above the adjusted loss tolerance and may thus be rejected as an acceptable compression approach. Because the quantized PCA (e.g., of FIG. 15E) yields the highest compression rate at compression dimension 300, the optimal compression strategy, when selecting between PCA and DCT, may be PCAq and the optimal compression rate may be 300.

FIG. 15G may illustrate a third graph depicting a plurality of compression configuration outcomes 1599 (e.g., optimal compression values) as a function of loss tolerance 1597 and number of neighbors 1598. Loss tolerance 1597 may refer to the user-configured loss tolerance (e.g., the loss tolerance input to the automated vector embedding compression system). Number of neighbors 1598 may refer to the number of neighbors determined for each vector embedding when calculating the neighbor preservation metric. Generally, as the number of neighbors 1598 increases, the optimal compression value for a particular loss tolerance may increase. Additionally, as the loss tolerance 1597 increases, the optimal compression value for a particular number of numbers may decrease.

In a non-limiting example, as described with reference to FIG. 15G, adjusted loss tolerance may vary depending on the number of neighbors retrieved. For instance, the adjusted loss tolerance may increase as the number of nearest neighbors retrieved increases. This increase may occur due to an increase of neighbors included in the calculations, thus increasing a likelihood that a very near neighbor will be completely removed from the set of nearest neighbors may decrease. In addition to loss tolerance adjustments, the optimal compression values may also be impacted. For instance, in one example, the optimal compression configuration for a nearest neighbors number of 10 may be PCAq of 175, the optimal compression configuration for a nearest neighbor number of 5 may be a PCAq of 150 and the optimal compression configuration for a nearest neighbor number of 1 may be a PCAq of 75. FIG. 15G may illustrate the dependency of the optimal compression level as a function of loss tolerance and the number of neighbors retrieved.

In some examples, the automated vector embedding compression system may receive a second plurality of vector embeddings having a second initial dimension different from the initial dimension (e.g., some other number besides 384). In such examples, the automated vector embedding compression system may detect a second optimal compression configuration for the second plurality of vector embeddings.

In some examples, the automated vector embedding compression system may only perform the compression on vector embeddings when the plurality of vector embeddings exceeds a target memory size. After performing the compression, the corresponding projected and/or quantized vector embeddings may no longer exceed the target memory size. An edge device may define the target memory size for storing the plurality of vector embeddings.

Once the optimal compression configuration is determined, the automated vector embedding compression system may output the vector embeddings compressed according to the optimal compression configuration and may install the compressed vector embeddings into a target database (e.g., a target vector database). For instance, in a non-limiting example as depicted with reference to FIGS. 15A-1, 15A-2, and 15D, if the optimal compression configuration is a compression level of 294 and a dimension reduction algorithm of DCTq (e.g., corresponding to vector embedding set 1520A), vector embeddings 1548A, 1548B, 1548C, and 1548N may be output by automated vector embedding compression system 1580 and stored in (e.g., installed at) vector database 1590.

In some examples, a first subset of the vector embeddings provided to the vector database may be compressed according to the optimal compression configuration and a second subset of the vector embeddings may remain uncompressed. In such examples, the vector embeddings within the first subset may be selected at random or may be selected based on one or more heuristic criteria. Accordingly, the vector database may include uncompressed vector embeddings, compressed but unquantized vector embeddings, and quantized vector embeddings corresponding to the same or different subsets of documents. The presence of such differentiated embedding types within the vector database may allow retrieval operations to leverage compressed or quantized embeddings to achieve lower memory utilization and faster response times while preserving uncompressed embeddings for higher-fidelity search operations. Accordingly, the vector database may balance memory footprint, retrieval latency, and similarity accuracy.

Once the vector embeddings are included within the target database, the target database may be used within a RAG pipeline (e.g., RAG pipeline 1592 of FIG. 15D). For instance, when an input for an LLM is retrieved, the input may be transformed into an embedding and used to identify and retrieve the most relevant vector embeddings within the target database (e.g., based on a proximity of the input vector embedding relative to vector embeddings within the vector database). The vector embeddings retrieved may be compressed according to the optimal compression configuration. The corresponding text from these most relevant vector embeddings may be provided to the LLM as context. In some examples, the input vector embedding may be compressed and/or quantized according to the optimal compression configuration. In other examples, the input vector embedding may be compressed and/or quantized according to other dimension reduction techniques (e.g., discrete wavelet transform for image data, video data, or audio data). It should be noted that the vector embedding techniques described herein may be utilized in other applications in which vector databases are used without deviating from the scope of the present disclosure.

A model evaluator may evaluate a performance of the selected compression configuration relative to other compression configurations. For instance, the model evaluator may determine efficacy metrics (e.g., RAG metrics) that measure an efficacy of an LLM in responding to user queries using a respective vector embedding subset (e.g., a respective quantized and/or projected vector embedding set). For instance, in a non-limiting example as described with reference to FIGS. 15A-1 and 15A-2, a first efficacy metric may be determined for vector embedding set 1518C and a second efficacy metric may be determined for vector embedding set 1518B. An example of a model evaluator may include model evaluator 1594 of FIG. 15D and examples of efficacy metrics may include efficacy metrics 1596A, 1596B, 1596C, 1596D and 1596N of FIG. 15D.

If multiple vector embedding sets satisfy a target error tolerance but at least one of the vector embedding sets has a corresponding efficacy metric that fails to satisfy pre-defined efficacy criteria, then the at least one of the vector embedding sets with the failing efficacy metric may be removed for consideration as the vector embeddings associated with the optimal compression configuration. That is, the optimal compression configuration may be based on the neighbor preservation metric computed for each vector embedding subset against the target error tolerance and further based on one or more efficacy metrics (e.g., RAG metrics). For instance, the automated vector embedding compression system may detect that the neighbor preservation metric computed for a first vector embedding subset and the neighbor preservation metric computed for a second vector embedding subset in the quantized first set of projected vector embeddings and the quantized second set of projected vector embeddings satisfy the target error tolerance. However, the model evaluator may detect that a first retrieval-augmented generation metric satisfies pre-defined efficacy criteria and a second retrieval-augmented generation metric does not satisfy the pre-defined efficacy criteria. Accordingly, in response to the model evaluator detecting that the first retrieval-augmented generation metric satisfies the pre-defined efficacy criteria and the second retrieval-augmented generation metric does not satisfy the pre-defined efficacy criteria, the automated vector embedding compression system may determine that the optimal compression configuration is associated with the first vector embedding subset if the respective vector embedding subset associated with the first retrieval-augmented generation metric corresponds to the first vector embedding subset. Alternatively, the automated vector embedding compressions system may detect that the optimal compression configuration is associated with the second vector embedding subset when the respective vector embedding subset associated with the first retrieval-augmented generation metric corresponds to the second vector embedding subset.

Alternatively, the efficacy metrics may correspond to just the initially selected optimal compression configuration. In such examples, the efficacy metric values may measure a faithfulness of responses generated using the compressed set of vector embeddings (e.g., efficacy metric 1596A), a measure of the relevancy of returned contextual information associated with the compressed set of vector embeddings (e.g., efficacy metric 1596B), and/or a measure of the accuracy of the response (e.g., efficacy metric 1596C). If one or more of such metrics fail to satisfy respective thresholds, a new compression configuration may be selected (e.g., the compression configuration associated with the next smallest memory footprint that still satisfies an adjusted error tolerance threshold).

Techniques utilizing KNN may optimize for local preservation between vector embeddings. Other techniques may be employed that may optimize for global preservation. For instance, the automated vector embedding compression system may evaluate compression quality based on a centroid drift metric, which measures the displacement of cluster centroids before and after compression. This approach may be used to assess preservation of global structural relationships across embedding clusters. Such techniques may be used for medical or legal corpora. In such examples, the centroid drift metrics may be used to select the optimal compression configuration. Additionally, or alternatively, cosine similarity (e.g., cosine distance) between vector embeddings may be calculated and used to determine the optimal compression configuration along with and/or instead of the neighbor preservation metric.

It shall be noted that, in the method(s) described herein where one or more steps (e.g., processes) are contingent upon one or more conditions having been met, it should be understood that the described method can be repeated in multiple repetitions so that over the course of the repetitions all of the conditions upon which steps in the method are contingent have been met in different repetitions of the method. For example, if a method requires performing a first step if a condition is satisfied, and a second step if the condition is not satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that is repeated until each of the conditions described in the method has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a method until all of the conditions upon which steps in the method are contingent have been met. A person having ordinary skill in the art would also understand that, similar to a method with contingent steps, a system or computer readable storage medium can repeat the steps of a method as many times as are needed to ensure that all of the contingent steps have been performed.

It shall also be noted that the system and methods of the embodiments and variations described herein can be embodied and/or implemented at least in part as a machine comprising a computer-readable medium storing computer-readable instructions. The instructions may be executed by computer-executable components integrated with the system and one or more portions of the processors and/or the controllers. The computer-readable medium can be stored on any suitable computer-readable media such as RAMs, ROMs, flash memory, EEPROMs, optical devices (CD or DVD), hard drives, floppy drives, memory sticks (e.g., SD cards, USB flash drives), cloud-based services (e.g., cloud storage), magnetic storage devices, Solid-State Drives (SSDs), or any suitable device. The computer-executable component is preferably a general or application-specific processor, but any suitable dedicated hardware or hardware/firmware combination device can alternatively or additionally execute the instructions.

The systems and methods of the preferred embodiments may additionally, or alternatively, be implemented on an integrated data analytics software application and/or software architecture such as those offered by SAS Institute Inc. of Cary, N.C., USA. Merely for illustration, the systems and methods of the preferred embodiments may be implemented using or integrated with one or more SAS software tools such as SAS® Viya™ which is developed and provided by SAS Institute Inc. of Cary, N.C., USA.

Although omitted for conciseness, the preferred embodiments include every combination and permutation of the implementations of the systems and methods described herein.

As a person skilled in the art will recognize from the previous detailed description and from the figures and claims, modifications and changes can be made to the embodiments of the disclosure without departing from the scope of the various described embodiments.

1. A computer-program product comprising a non-transitory machine-readable storage medium storing computer instructions that, when executed by one or more processors, perform operations comprising:
receiving a plurality of vector embeddings having an initial dimension;
projecting the plurality of vector embeddings into a plurality of dimensions lower than the initial dimension, wherein projecting the plurality of vector embeddings into the plurality of dimensions lower than the initial dimension includes:
generating, via a first dimension reduction algorithm, a first set of projected vector embeddings corresponding to the plurality of dimensions lower than the initial dimension, and
generating, via a second dimension reduction algorithm, a second set of projected vector embeddings corresponding to the plurality of dimensions lower than the initial dimension;
transforming the first set of projected vector embeddings into a quantized first set of projected vector embeddings and the second set of projected vector embeddings into a quantized second set of projected vector embeddings;
computing a set of nearest neighbors for each vector embedding in the plurality of vector embeddings, the quantized first set of projected vector embeddings, and the quantized second set of projected vector embeddings;
based on the set of nearest neighbors computed for each vector embedding, computing a neighbor preservation metric for each vector embedding subset in the quantized first set of projected vector embeddings and the quantized second set of projected vector embeddings, wherein:
a first neighbor preservation metric computed for a first vector embedding subset in the quantized first set of projected vector embeddings and the quantized second set of projected vector embeddings has a first value, and
a second neighbor preservation metric computed for a second vector embedding subset in the quantized first set of projected vector embeddings and the quantized second set of projected vector embeddings has a second value, lower than the first value; and
detecting an optimal data compression configuration for the plurality of vector embeddings by assessing the neighbor preservation metric computed for each vector embedding subset against a target error tolerance, wherein detecting the optimal data compression configuration includes:
detecting that the first value associated with the first neighbor preservation metric and the second value associated with the second neighbor preservation metric exceed the target error tolerance, and
determining that the second vector embedding subset associated with the second neighbor preservation metric corresponds to the optimal data compression configuration when the second vector embedding subset comprises a fewer number of components than the first vector embedding subset associated with the first neighbor preservation metric.

2. The computer-program product according to claim 1, wherein computing the set of nearest neighbors for a respective vector embedding in a target set of vector embeddings corresponding to one of the plurality of vector embeddings, the quantized first set of projected vector embeddings, and the quantized second set of projected vector embeddings includes:
computing a plurality of vector distances between the respective vector embedding and additional vector embeddings in the target set of vector embeddings, and
based on the plurality of vector distances:
detecting a subset of the additional vector embeddings that have a shortest vector distance to the respective vector embedding relative to a remainder of the additional vector embeddings, and
selecting the subset of the additional vector embeddings as the set of nearest neighbors for the respective vector embedding.

3. The computer-program product according to claim 1, wherein the first set of projected vector embeddings generated via the first dimension reduction algorithm at least includes:
a third vector embedding subset that projects the plurality of vector embeddings in a first dimension of the plurality of dimensions lower than the initial dimension, and
a fourth vector embedding subset that projects the plurality of vector embeddings in a second dimension of the plurality of dimensions lower than the initial dimension.

4. The computer-program product according to claim 3, wherein the second set of projected vector embeddings generated via the second dimension reduction algorithm at least includes:
a fifth vector embedding subset that projects the plurality of vector embeddings in the first dimension of the plurality of dimensions lower than the initial dimension, and
a sixth vector embedding subset that projects the plurality of vector embeddings in the second dimension of the plurality of dimensions lower than the initial dimension.

5. The computer-program product according to claim 1, wherein:
a respective vector embedding in the quantized first set of projected vector embeddings corresponds to a first vector embedding in the first set of projected vector embeddings and has a lower bit precision than a bit precision of the first vector embedding, and
a respective vector embedding in the quantized second set of projected vector embeddings corresponds to a second vector embedding in the second set of projected vector embeddings and has the lower bit precision than the bit precision of the second vector embedding.

6. The computer-program product according to claim 1, wherein:
the first set of projected vector embeddings and the second set of projected vector embeddings are concurrently computed by the first dimension reduction algorithm and the second dimension reduction algorithm, and
the first set of projected vector embeddings and the second set of projected vector embeddings are concurrently transformed into the quantized first set of projected vector embeddings and the quantized second set of projected vector embeddings.

7. The computer-program product according to claim 1, wherein the computer instructions, when executed by the one or more processors, perform the operations further comprising:
receiving, as input, the plurality of vector embeddings and a plurality of hyperparameters, including:
a hyperparameter that defines the target error tolerance,
a hyperparameter that defines a number of nearest neighbors to include in the set of nearest neighbors computed for each vector embedding, and
a hyperparameter that defines a compression interval used to determine the plurality of dimensions lower than the initial dimension.

8. The computer-program product according to claim 1, wherein:
a respective vector embedding of the plurality of vector embeddings corresponds to a numerical representation of a document in a target embedding space, and
the initial dimension corresponds to a number of numerical features included in the numerical representation.

9. The computer-program product according to claim 1, wherein computing the neighbor preservation metric for a respective vector embedding subset in one of the quantized first set of projected vector embeddings and the quantized second set of projected vector embeddings includes:
detecting one or more nearest neighbor variants in the respective vector embedding subset by assessing the set of nearest neighbors computed for each vector embedding in the respective vector embedding subset against the set of nearest neighbors computed for each vector embedding in the plurality of vector embeddings, and
computing a proportion of nearest neighbors preserved in the respective vector embedding subset based on a count of the one or more nearest neighbor variants relative to a total number of nearest neighbors computed across the plurality of vector embeddings.

10. The computer-program product according to claim 1, wherein the computer instructions, when executed by the one or more processors, perform operations further comprising:
computing a second set of nearest neighbors for each vector embedding in the plurality of vector embeddings,
computing a proportion of nearest neighbors preserved between the set of nearest neighbors and the second set of nearest neighbors computed for each vector embedding in the plurality of vector embeddings, and
adjusting the target error tolerance by subtracting the proportion of nearest neighbors preserved between the set of nearest neighbors and the second set of nearest neighbors from the target error tolerance.

11. The computer-program product according to claim 1, wherein detecting the optimal data compression configuration for the plurality of vector embeddings includes:
detecting that a third neighbor preservation metric computed for a third vector embedding subset in the quantized first set of projected vector embeddings and the quantized second set of projected vector embeddings does not satisfy the target error tolerance,
detecting that the third vector embedding subset is associated with a fewer number of components than the second vector embedding subset, and
based on detecting that the third vector embedding subset has the fewer number of components than the second vector embedding subset, that the third neighbor preservation metric does not satisfy the target error tolerance, and that the first value associated with the first neighbor preservation metric and the second value associated with the second neighbor preservation metric exceed the target error tolerance:
determining that the second vector embedding subset associated with the second neighbor preservation metric corresponds to the optimal data compression configuration when the second vector embedding subset comprises the fewer number of components than the first vector embedding subset associated with the first neighbor preservation metric, wherein:
the optimal data compression configuration comprises a number of components and a dimension reduction algorithm associated with the second neighbor preservation metric computed for the second vector embedding subset.

12. The computer-program product according to claim 1, wherein the optimal data compression configuration defines an optimal compression level and an optimal dimension reduction algorithm for the plurality of vector embeddings.

13. The computer-program product according to claim 1, wherein the computer instructions, when executed by the one or more processors, perform operations further comprising:
receiving, via an event stream processing engine (ESPE), a plurality of documents;
partitioning, via the event stream processing engine, the plurality of documents into a plurality of document segments;
computing, via the event stream processing engine, the plurality of vector embeddings corresponding to the plurality of document segments; and
receiving, by an automated compression component of the event stream processing engine, the plurality of vector embeddings having the initial dimension.

14. The computer-program product according to claim 13, wherein the event stream processing engine receives the plurality of documents as a stream over a period of time.

15. The computer-program product according to claim 13, wherein:
a respective document of the plurality of documents is a multi-modal document,
the multi-modal document comprises at least two distinct modalities,
a first modality of the at least two distinct modalities corresponds to one of: video data, image data, audio data, and text data, and
a second modality of the at least two distinct modalities corresponds to a different one of: the video data, the image data, the audio data, and the text data.

16. The computer-program product according to claim 1, wherein the computer instructions, when executed by the one or more processors, perform operations further comprising:
installing, via an event stream processing engine (ESPE), the plurality of vector embeddings into a target database using the optimal data compression configuration.

17. The computer-program product according to claim 16, wherein installing the plurality of vector embeddings into the target database using the optimal data compression configuration comprises:
compressing a first subset of the plurality of vector embeddings using the optimal data compression configuration; and
storing the compressed first subset of the plurality of vector embeddings and a second subset of the plurality of vector embeddings at the target database, wherein the second subset of the plurality of vector embeddings has the initial dimension.

18. The computer-program product according to claim 1, wherein the computer instructions, when executed by the one or more processors, perform operations further comprising:
generating a data compression efficacy artifact for the plurality of vector embeddings, wherein the data compression efficacy artifact includes one or more of:
a first graph depicting a relationship between a number of components and a proportion of nearest neighbors preserved for the first dimension reduction algorithm,
a second graph depicting a relationship between the number of components and the proportion of nearest neighbors preserved for the second dimension reduction algorithm, and
a third graph depicting a plurality of data compression configuration outcomes as a function of loss tolerance and number of neighbors.

19. The computer-program product according to claim 1, wherein the optimal data compression configuration is detected by assessing the neighbor preservation metric computed for each vector embedding subset against the target error tolerance and further based on one or more retrieval-augmented generation (RAG) metrics.

20. The computer-program product according to claim 19, wherein each of the one or more retrieval-augmented generation metrics measures an efficacy of a large language model in responding to user queries using a respective vector embedding subset of the quantized first set of projected vector embeddings and the quantized second set of projected vector embedding.

21. The computer-program product according to claim 20, wherein:
detecting the optimal data compression configuration for the plurality of vector embeddings includes:
detecting that the first neighbor preservation metric computed for the first vector embedding subset and the second neighbor preservation metric computed for the second vector embedding subset in the quantized first set of projected vector embeddings and the quantized second set of projected vector embeddings satisfy the target error tolerance,
detecting that a first retrieval-augmented generation metric satisfies pre-defined efficacy criteria and a second retrieval-augmented generation metric does not satisfy the pre-defined efficacy criteria, and
in response to detecting that the first retrieval-augmented generation metric satisfies the pre-defined efficacy criteria and the second retrieval-augmented generation metric does not satisfy the pre-defined efficacy criteria:
determining that the optimal data compression configuration is associated with the second vector embedding subset when the first retrieval-augmented generation metric corresponds to the second vector embedding subset and the second vector embedding subset comprises the fewer number of components than the first vector embedding subset associated with the first neighbor preservation metric.

22. The computer-program product according to claim 21, wherein:
in response to detecting that the first retrieval-augmented generation metric satisfies the pre-defined efficacy criteria and the second retrieval-augmented generation metric does not satisfy the pre-defined efficacy criteria:
forgoing detecting that the optimal data compression configuration is associated with the second vector embedding subset when the first retrieval-augmented generation metric corresponds to the first vector embedding subset.

23. The computer-program product according to claim 1, wherein:
the set of nearest neighbors are further computed for each vector embedding in the first set of projected vector embeddings and the second set of projected vector embeddings,
the neighbor preservation metric is further computed for each vector embedding subset in the first set of projected vector embeddings and the second set of projected vector embeddings, and
detecting the optimal data compression configuration for the plurality of vector embeddings includes:
detecting if a retrieval-augmented generation metric computed for each vector embedding subset in the quantized first set of projected vector embeddings and the quantized second set of projected vector embeddings satisfies pre-defined efficacy criteria,
if the retrieval-augmented generation metric computed for each vector embedding subset in the quantized first set of projected vector embeddings and the quantized second set of projected vector embeddings satisfies the pre-defined efficacy criteria:
determining that the second vector embedding subset associated with the second neighbor preservation metric corresponds to the optimal data compression configuration when the second vector embedding subset comprises the fewer number of components than the first vector embedding subset associated with the first neighbor preservation metric, and
if the retrieval-augmented generation metric computed for each vector embedding subset in the quantized first set of projected vector embeddings and the quantized second set of projected vector embeddings does not satisfy the pre-defined efficacy criteria:
detecting that a third neighbor preservation metric computed for a third vector embedding subset in the first set of projected vector embeddings satisfies the target error tolerance and that a respective retrieval-augmented generation metric computed for the third vector embedding subset satisfies the pre-defined efficacy criteria, and
selecting a number of components and a dimension reduction algorithm associated with the third neighbor preservation metric computed for the third vector embedding subset as the optimal data compression configuration for the plurality of vector embeddings.

24. The computer-program product according to claim 1, wherein:
the plurality of vector embeddings exceed a target memory size,
the second vector embedding subset of the quantized first set of projected vector embeddings and the quantized second set of projected vector embeddings has the fewer number of components than the first vector embedding subset associated with the first neighbor preservation metric, and
the second vector embedding subset associated with the second neighbor preservation metric does not exceed the target memory size.

25. The computer-program product according to claim 24, wherein an edge device defines the target memory size for storing the plurality of vector embeddings.

26. The computer-program product according to claim 1, wherein the computer instructions, when executed by the one or more processors, perform the operations comprising:
receiving a second plurality of vector embeddings having a second initial dimension, different from the initial dimension, and
detecting a second optimal compression configuration for the second plurality of vector embeddings.

27. The computer-program product according to claim 1, wherein the computer instructions, when executed by the one or more processors, perform the operations further comprising:
outputting, to a graphical user interface, an indication of the detected optimal compression configuration.

28. A computer-implemented method, comprising:
receiving a plurality of vector embeddings having an initial dimension;
projecting the plurality of vector embeddings into a plurality of dimensions lower than the initial dimension, wherein projecting the plurality of vector embeddings into the plurality of dimensions lower than the initial dimension includes:
generating, via a first dimension reduction algorithm, a first set of projected vector embeddings corresponding to the plurality of dimensions lower than the initial dimension, and
generating, via a second dimension reduction algorithm, a second set of projected vector embeddings corresponding to the plurality of dimensions lower than the initial dimension;
transforming the first set of projected vector embeddings into a quantized first set of projected vector embeddings and the second set of projected vector embeddings into a quantized second set of projected vector embeddings;
computing a set of nearest neighbors for each vector embedding in the plurality of vector embeddings, the quantized first set of projected vector embeddings, and the quantized second set of projected vector embeddings;
based on the set of nearest neighbors computed for each vector embedding, computing a neighbor preservation metric for each vector embedding subset in the quantized first set of projected vector embeddings and the quantized second set of projected vector embeddings, wherein:
a first neighbor preservation metric computed for a first vector embedding subset in the quantized first set of projected vector embeddings and the quantized second set of projected vector embeddings has a first value, and
a second neighbor preservation metric computed for a second vector embedding subset in the quantized first set of projected vector embeddings and the quantized second set of projected vector embeddings has a second value, lower than the first value; and
detecting an optimal data compression configuration for the plurality of vector embeddings by assessing the neighbor preservation metric computed for each vector embedding subset against a target error tolerance, wherein detecting the optimal data compression configuration includes:
detecting that the first value associated with the first neighbor preservation metric and the second value associated with the second neighbor preservation metric exceed the target error tolerance, and
determining that the second vector embedding subset associated with the second neighbor preservation metric corresponds to the optimal data compression configuration when the second vector embedding subset comprises a fewer number of components than the first vector embedding subset associated with the first neighbor preservation metric.

29. The computer-implemented method according to claim 28, wherein computing the set of nearest neighbors for a respective vector embedding in a target set of vector embeddings corresponding to one of the plurality of vector embeddings, the quantized first set of projected vector embeddings, and the quantized second set of projected vector embeddings includes:
computing a plurality of vector distances between the respective vector embedding and additional vector embeddings in the target set of vector embeddings, and
based on the plurality of vector distances:
detecting a subset of the additional vector embeddings that have a shortest vector distance to the respective vector embedding relative to a remainder of the additional vector embeddings, and
selecting the subset of the additional vector embeddings as the set of nearest neighbors for the respective vector embedding.

30. A computer-implemented system comprising:
one or more processors;
a memory; and
a computer-readable medium operably coupled to the one or more processors, the computer-readable medium having computer-readable instructions stored thereon that, when executed by the one or more processors, cause a computing device to perform operations comprising:
receiving a plurality of vector embeddings having an initial dimension;
projecting the plurality of vector embeddings into a plurality of dimensions lower than the initial dimension, wherein projecting the plurality of vector embeddings into the plurality of dimensions lower than the initial dimension includes:
generating, via a first dimension reduction algorithm, a first set of projected vector embeddings corresponding to the plurality of dimensions lower than the initial dimension, and
generating, via a second dimension reduction algorithm, a second set of projected vector embeddings corresponding to the plurality of dimensions lower than the initial dimension;
transforming the first set of projected vector embeddings into a quantized first set of projected vector embeddings and the second set of projected vector embeddings into a quantized second set of projected vector embeddings;
computing a set of nearest neighbors for each vector embedding in the plurality of vector embeddings, the quantized first set of projected vector embeddings, and the quantized second set of projected vector embeddings;
based on the set of nearest neighbors computed for each vector embedding, computing a neighbor preservation metric for each vector embedding subset in the quantized first set of projected vector embeddings and the quantized second set of projected vector embeddings, wherein:
a first neighbor preservation metric computed for a first vector embedding subset in the quantized first set of projected vector embeddings and the quantized second set of projected vector embeddings has a first value, and
a second neighbor preservation metric computed for a second vector embedding subset in the quantized first set of projected vector embeddings and the quantized second set of projected vector embeddings has a second value, lower than the first value; and
detecting an optimal compression configuration for the plurality of vector embeddings by assessing the neighbor preservation metric computed for each vector embedding subset against a target error tolerance, wherein detecting the optimal data compression configuration includes:
detecting that the first value associated with the first neighbor preservation metric and the second value associated with the second neighbor preservation metric exceed the target error tolerance, and
determining that the second vector embedding subset associated with the second neighbor preservation metric corresponds to the optimal data compression configuration when the second vector embedding subset comprises a fewer number of components than the first vector embedding subset associated with the first neighbor preservation metric.

31. The computer-program product according to claim 1, wherein:
a third neighbor preservation metric that has a third value is computed for a third vector embedding subset in the quantized first set of projected vector embeddings and the quantized second set of projected vector embeddings, and
detecting the optimal data compression configuration further includes detecting that the third value associated with the third neighbor preservation metric does not exceed the target error tolerance.

32. The computer-program product according to claim 1, wherein the optimal data compression configuration enables the plurality of vector embeddings to be stored in a vector database with a lower amount of memory than when the plurality of vector embeddings have the initial dimension.

33. The computer-program product according to claim 1, wherein:
the optimal data compression configuration indicates an optimal compression dimension, lower than the initial dimension, and an optimal dimension reduction algorithm, and
the computer instructions, when executed by the one or more processors, perform the operations comprising:
compressing the plurality of vector embeddings from the initial dimension to the optimal compression dimension using the optimal dimension reduction algorithm, and
installing the plurality of vector embeddings having the optimal compression dimension into a vector database.

34. The computer-program product according to claim 33, wherein:
the vector database requires a lower amount of memory to store the plurality of vector embeddings with the optimal compression dimension than when the plurality of vector embeddings have the initial dimension, and
the lower amount of memory is at least one of 1 GB, 2 GB, 10 GB, and 20 GB.

35. The computer-program product according to claim 33, wherein:
the vector database requires a lower amount of memory to store the plurality of vector embeddings with the optimal compression dimension than when the plurality of vector embeddings have the initial dimension, and
the lower amount of memory is at least one of 50 GB, 100 GB, and 200 GB.

36. The computer-program product according to claim 33, wherein:
the vector database requires a lower amount of memory to store the plurality of vector embeddings with the optimal compression dimension than when the plurality of vector embeddings have the initial dimension, and
the lower amount of memory is at least one of 1 TB, 10 TB, and 30 TB.

37. The computer-program product according to claim 33, wherein the computer instructions, when executed by the one or more processors, perform the operations comprising:
receiving a user input via a machine learning model;
converting, via the machine learning model, the user input into a respective vector embedding;
searching the vector database using the respective vector embedding associated with the user input, wherein a result of the searching of the vector database includes a subset of the plurality of vector embeddings that have a closer vector distance to the respective vector embedding associated with the user input than a remainder of the plurality of vector embeddings having the optimal compression dimension;
generating, via the machine learning model, a prediction based on the user input and the subset of the plurality of vector embeddings; and
transforming the prediction from a first data format to a second data format.

38. The computer-program product according to claim 37, wherein:
the machine learning model comprises a neural network,
the neural network comprises a plurality of layers that exchange data via a plurality of connections, and
the plurality of layers include:
an input layer for receiving the user input,
a plurality of hidden layers, and
an output layer for providing the prediction.

39. The computer-program product according to claim 38, wherein:
the plurality of layers include a plurality of neurons,
the plurality of neurons and the plurality of connections are associated with a plurality numeric weights, and
training the machine learning model includes:
inputting training data to the input layer of the machine learning model, and
using the training data to tune the plurality numeric weights associated with the plurality of neurons and the plurality of connections.

40. The computer-program product according to claim 39, wherein using the training data to tune the plurality numeric weights includes:
(a) determining a gradient of each respective numeric weight based on a difference between an actual output of the neural network at the output layer and a target output of the neural network,
(b) based on the gradient of each respective numeric weight, updating the plurality numeric weights to reduce the difference between the actual output of the neural network at the output layer and the target output of the neural network, and
(c) repeating (a)-(b) at least a thousand of times.
